(19) United States
(12) Patent Application Publication
(10) Pub. No.: US 2025/0078152 A1
(43) Pub. Date: Mar. 6, 2025

(54) COMPUTER SYSTEM FOR ON-DEMAND MARGIN BORROWING AND LENDING

(71) Applicant: Bullish Global, Grand Cayman (KY)

(72) Inventors: Justin Paul Short, Twickenham (GB); Mark Woods, Radford, VA (US); Shashank Singh Solanki, Singapore (SG); Khaled Assaad Al-Hassanieh, Blacksburg, VA (US); Samuel Hakim, Mid Levels (HK); Weixin Sun, West New York, NJ (US); Aditya Gopinath, Causeway Bay (HK); Maxime Antonie, Singapore (SG); Yawei Xia, Jersey City, NJ (US); Ian Temple, Roanoke, VA (US); Brian Huang, Richmond, VA (US)

(21) Appl. No.: 18/793,679

(22) Filed: Aug. 2, 2024

Related U.S. Application Data
(60) Provisional application No. 63/517,320, filed on Aug. 2, 2023.

(51) Int. Cl. G06Q 40/04; G06Q 40/06

(52) U.S. Cl. CPC G06Q 40/04; G06Q 40/06; G06Q 2220/00

(57) ABSTRACT

Embodiments relate to systems and methods for on-demand margin borrowing and lending with automated de-leveraging. The method for on-demand margin borrowing and lending with automated de-leveraging executing instructions stored on memory by a hardware processor, can involve: enabling margin on a subaccount for cross-collateralization of assets; setting leverage threshold values for the subaccount; processing a loan request to buy or sell an asset from a borrower interface; processing a loan offer to generate returns from idle assets from a lender interface; determining rate for assets; executing a margin transaction between the borrower interface and a lender interface, the margin transaction being smart contract code for a blockchain infrastructure; and computing different types of margin data, and generating output for transmission, storage, or display at an interface.

### CROSS-REFERENCE

This application claims priority to U.S. Provisional Patent Application No. 63/517,320 filed Aug. 2, 2023, entitled “COMPUTER SYSTEM FOR ON-DEMAND MARGIN BORROWING AND LENDING” the disclosure of which is hereby incorporated in its entirety.

### FIELD

The improvements generally relate to the field of distributed computer systems, executable programs, smart contract code, trading platforms, blockchains, and blockchain infrastructure.

### INTRODUCTION

Distributed computer systems can implement decentralized exchange platforms. Embodiments described herein relate to an exchange platform that connects to electronic devices to receive order commands for peer-to-peer margin borrowing and lending, including cryptocurrencies and digital assets. Embodiments described herein relate to an exchange platform for peer-to-peer margin borrowing and lending with automated de-leveraging. Embodiments described herein relate to an exchange platform for peer-to-peer margin borrowing and lending with a blockchain infrastructure integrating cryptographic and security tools.

There exists a need for improved exchange platforms.

### SUMMARY

In an aspect, embodiments described herein provide systems and methods for on-demand margin borrowing and lending.

In an aspect, embodiments described herein provide a computer system for on-demand margin borrowing and lending. The system has a memory storing historical trading data and instructions for a plurality of customer accounts, each customer account being a unified trading account; a hardware processor executing instructions to provide a margin processor configured to provide margin operations for the plurality of customer accounts for on-demand margin lending, on-demand margin borrowing, and interest charges, wherein the margin processor: determines that the customer account is operating in a margin mode to use assets on-demand for trading activities, wherein the computer system uses assets in the customer account as collateral for the trading activities; continuously computes a margin value for the customer account based on a collateral rating for the assets in the customer account used as collateral for the trading activities, wherein the collateral rating reflects a quality of the assets in the customer account based on a statistical analysis of historical trading data to determine, for each type of the assets in the customer account, a quality rating for a respective type of the asset in the customer account as an assessment of volatility or market risk of the asset in the customer account and an ability to liquidate the asset in the customer account, wherein the collateral rating is adapted to change proportionally with a value of the assets in the customer account, and automatically controls the trading activities for the customer account operating in the margin mode using the continuously computed margin value for the customer account; and a margin interface that outputs one or more visual elements corresponding to at least a portion of the margin value for the customer account operating in the margin mode, and updates the one or more visual elements as the margin value is continuously computed.

In some embodiments, the margin processor sets one or more margin requirements for the customer account, and continuously compares the margin value for the customer account to the margin requirements to evaluate risk for the customer account, wherein the margin processor controls the trading activities for the customer account operating in the margin mode using the one or more margin requirements. For example, trading activities may impact the margin value and the system continuously computes the margin value to reflect the various trading activities over time and compares the margin value to the margin requirements for continuous monitoring and control of the account and trading activities.

In some embodiments, the margin processor computes a health indicator for the customer account based on the margin value and the margin requirements, the health indicator corresponding to one or more permitted actions for the customer account, wherein the computer system executes code to control activities for the customer account using the one or more permitted actions corresponding to the health indicator for the customer account.

In some embodiments, upon determining that the margin value for the customer account does not meet the margin requirements for the customer account, the margin processor updates the one or more permitted actions for the customer account, wherein upon receiving a request for an activity for a customer account, the system verifies the one or more permitted actions corresponding to the health indicator for the customer account before implementing the requested activity, wherein upon determining that the requested activity is not include in the one or more permitted actions corresponding to the health indicator for the customer account, the computer system rejects the request for the activity for the customer account.

In some embodiments, the margin processor computes the collateral rating for the assets in the customer account used as collateral for the trading activities by discounting a normalized value of all types of assets in the customer account by a rating reflective of a quality measure of the assets in the customer account, wherein a higher quality asset will have a higher rating and lower haircut, and a lower quality asset will have a lower rating and higher haircut.

In some embodiments, the margin processor computes the collateral rating for the assets in the customer account as collateral value-haircut, wherein the collateral value is a normalized value of the assets in the customer account and a haircut reflects a quality measure of the assets in the customer account, wherein a higher quality reflects a lower haircut, and a lower quality reflects a higher haircut.

In some embodiments, the margin processor computes the margin value for the customer account as: margin=(collateral value−haircut)+futures pnl−debt.

In some embodiments, a computer system further comprises a dispatcher, a matcher, a marginer, a market maker, and an accountant engine to implement one or more of the trading activities for the customer account.

In some embodiments, the margin processor: enables margin trading on a subaccount; sets margin requirements for the subaccount; processes a loan request to buy or sell an asset from a borrower interface; processes a loan offer to generate returns from idle assets from a lender interface; determines rates for assets in the customer account; executes a margin transaction between the borrower interface and the lender interface, the margin transaction being smart contract code for a blockchain infrastructure; and computes different types of margin data, and generates output for transmission, storage or display at the margin interface.

In some embodiments, the margin processor is further configured to automatically update the one or more visual elements of the margin interface using output data relating to a margin transaction, the one or more visual elements indicating a risk value for the margin transaction and the margin requirements for a subaccount.

In some embodiments, the computer system further comprises a liquidation engine configured to process automatic de-leveraging of a subaccount, wherein the liquidation engine automatically liquidates assets in the subaccount when a leverage threshold value of the subaccount is above a safety threshold value.

In some embodiments, the safety threshold value is at least one of: a default value; and an adaptive value configured by the computer system in response to continuously computing the margin value and comparing to the margin requirements.

In some embodiments, the liquidation engine is further configured to set a liquidation price of an asset held in the subaccount.

In some embodiments, output data relating to a margin transaction includes an impact of a planned margin transaction, wherein the impact of the planned margin transaction is determined by the margin processor and the impact of the planned action is at least one of: additional assets that will be borrowed as a result of the planned margin transaction; a total of the additional assets that will be borrowed as a result of the planned margin transaction; an asset price at which a user will lose control of the subaccount to the liquidation engine as a result of the planned margin transaction; an expected leverage of the subaccount as a result of the planned margin transaction; expected fees as a result of the planned margin transaction; and an expected notional as a result of the planned margin transaction.

In some embodiments, the margin processor is further configured to automatically process repayment of at least one loan of the subaccount by selling idle assets of the subaccount, wherein the margin processor is configured to determine the at least one loan by calculating the at least one loan with the highest loan rate.

In some embodiments, the margin processor is further configured to automatically processes a repayment of the at least one loan of the subaccount at a regular interval.

In some embodiments, the margin processor is further configured to process loan return data and loan capacity data for at least one of: an individual loan offer; and an aggregate of loan offers.

In some embodiments, the margin processor uses open order collateral assets in the subaccount for cross-collateralization, wherein the margin processor is further configured to set a leverage characterization status of the subaccount, the margin processor processing a current leverage value of the subaccount and a leverage threshold value of the subaccount to set the leverage characterization.

In some embodiments, the health indicator comprises a status selected from the group of healthy, monitor, danger, critical, and suspended.

In some embodiments, the margin interface further comprises a margin toggle configured to activate or deactivate the margin mode.

In an aspect, embodiments described herein provide a method for on-demand margin borrowing and lending executing instructions stored on memory by a hardware processor, the method comprising: determining that a customer account is operating in a margin mode to borrow assets on-demand for trading activities, wherein a trading system automatically uses assets in the customer account as collateral for the trading activities upon determining that the customer account is operating in the margin mode; and continuously computing a margin value for the customer account based on a collateral rating for the assets in the customer account used as collateral for the trading activities, wherein the collateral rating reflects a quality of the assets in the customer account based on a statistical analysis of historical trading data to determine, for each type of the assets in the customer account, a quality rating for a respective type of asset in the customer account as an assessment of volatility or market risk of the asset in the customer account and an ability to liquidate the asset in the customer account, wherein the collateral rating is adapted to change proportionally with a value of the assets in the customer account; automatically controlling the trading activities for the customer account operating in the margin mode using the continuously computed margin value for the customer account; outputting, at a margin interface, one or more visual elements corresponding to at least a portion of the margin value for the customer account operating in the margin mode, and updating the one or more visual elements as the margin value is continuously computed.

In an aspect, embodiments described herein provide a non-transitory machine readable medium having stored thereon a plurality of instructions that, when executed by at least one computing device, cause the at least one computing device to perform a method for on-demand margin borrowing and lending executing instructions stored on memory by a hardware processor.

In an aspect, embodiments described herein provide a computer system for on-demand margin borrowing and lending with automated de-leveraging. In some embodiments, the system has a memory storing instructions for a dispatcher, matcher, marginer, market maker, and an accountant engine, wherein the marginer includes margin data; and a hardware processor executing instructions to provide a margin processor for margin operations for lending, borrowing, interest charges, and a margin interface.

In some embodiments, the hardware processor: enables margin on a subaccount for cross-collateralization of assets; sets leverage threshold values for the subaccount; processes a loan request to buy or sell an asset from a borrower interface; processes a loan offer to generate returns from idle assets from a lender interface; determines rate for assets; executes a margin transaction between the borrower interface and a lender interface, the margin transaction being smart contract code for a blockchain infrastructure; computes different types of margin data, and generates output for transmission, storage, or display at the margin interface.

In some embodiments, the processor automatically updates one or more visual elements of the margin interface using output data relating to a margin transaction, the one or more visual elements indicating a risk value for the margin transaction and a leverage threshold value for a subaccount for the margin transaction.

In an aspect, embodiments described herein provide a method for on-demand margin borrowing and lending with automated de-leveraging executing instructions stored on memory by a hardware processor. The method involves: enabling margin on a subaccount for cross-collateralization of assets; setting leverage threshold values for the subaccount; processing a loan request to buy or sell an asset from a borrower interface; processing a loan offer to generate returns from idle assets from a lender interface; determining rate for assets; executing a margin transaction between the borrower interface and a lender interface, the margin transaction being smart contract code for a blockchain infrastructure; and computing different types of margin data, and generating output for transmission, storage, or display at an interface.

In an aspect, embodiments described herein provide non-transitory machine readable medium having stored thereon a plurality of instructions that, when executed by at least one computing device, cause the at least one computing device to enable margin on a subaccount for cross-collateralization of assets; set leverage threshold values for the subaccount; processes a loan request to buy or sell an asset from a borrower interface; process a loan offer to generate returns from idle assets from a lender interface; determine rate for assets; executes a margin transaction between the borrower interface and a lender interface, the margin transaction being smart contract code for a blockchain infrastructure; compute different types of margin data, and generate output for transmission, storage, or display at the margin interface.

### DESCRIPTION OF THE FIGURES

FIG. 1 shows a schematic diagram of a computer system for on-demand margin borrowing and lending.

FIG. 2 shows a diagram of process for on-demand margin borrowing and lending according to embodiments described herein.

FIG. 3 shows an example user interface with selectable indicia to trigger a request to enable margin mode on a subaccount.

FIG. 4 shows another example user interface displaying current leverage and a selectable indicia to trigger a request to enable margin mode on a subaccount.

FIG. 5 shows an example user interface.

FIG. 6 shows an example user interface with selectable indicia to edit or configure a leverage threshold value, with an example being between no leverage and 5×.

FIG. 7 shows an example user interface with selectable indicia to edit or configure a leverage threshold value.

FIGS. 8A, 8B, 8C, 8D show a schematic diagram of a computer system for on-demand margin borrowing and lending.

FIG. 9 shows an example electronic device for on-demand margin borrowing and lending.

FIG. 10 shows an example user interface with a current “health indicator” which displays the level of “health” based on the overall leverage of the subaccount.

FIG. 11 shows an example of the lender interface in which the lender can create a new loan or terminate an existing loan.

FIG. 12 shows an example of the second lender interface the lender will see when creating a loan.

FIG. 13 shows an example of the third lender interface the lender will see when creating a loan.

FIG. 14 shows an example of the final lender interface the lender will see when creating a loan.

FIG. 15 shows an example of the lender interface when the lender chooses to terminate an existing loan.

FIG. 16 shows an example of a user interface where a customer can view their current leverage and margin ratio values on a portfolio screen.

FIG. 17 shows an example trade input screen.

FIG. 18 shows an example of the borrower interface displaying borrowing history.

FIG. 19 shows an example user interface displaying borrowing history.

### DETAILED DESCRIPTION

Embodiments described herein provide systems and methods for on-demand margin borrowing and lending using code (e.g., smart contracts) executing on a decentralized or distributed exchange platform for trading assets, such as digital assets, in a regulated environment.

In an aspect, embodiments described herein provide systems and methods for on-demand margin borrowing and lending. Systems and methods can use an improved collateral process for on-demand margin borrowing and lending. Systems and methods can manage multiple unified trading accounts and enable margin mode for these accounts. Systems and methods can automatically compute a collateral rating as a range of values, for example. Systems and methods can use margin requirements to automatically and continuously assess the heath of assets in customer accounts for on-demand margin borrowing and lending. Systems and methods can compute margin values of a customer account and can continuously measure the health status of a customer account using margin requirements.

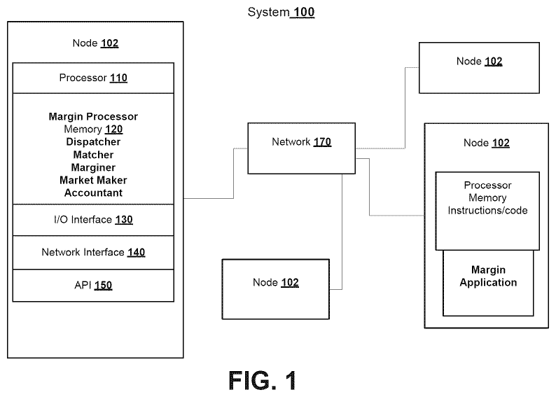

FIG. 1 shows a schematic diagram of a distributed computer system 100 for on-demand margin borrowing and lending. System 100 can implement on-demand margin trading for trading accounts to allow customers to borrow assets for the purposes of transacting on an exchange (“Margin Loans”) and to lend assets to fund Margin Loans. System 100 provides unified trading accounts with margin mode, and enables borrowers to maximize their trading power and capital efficiency by borrowing additional assets on-demand to trade for variable periods. Meanwhile, lenders can earn interest from their idle assets by creating loan offers that can be used by borrowers. System 100 can implement margin trading using cross-collateralized assets, so all assets in a unified trading account are used as potential collateral, even assets that are locked in limit orders, for example. Assets in other trading accounts might not be used as collateral for margin in the trading account.

For each of a plurality of customer accounts, system 100 can switch or toggle between different trading modes for the trading accounts. For example, system 100 can toggle between a “spot mode” and a “margin mode” for trading activities for a specific customer account. The system 100 can continuously monitor accounts to detect accounts with margin mode activated. In some examples, system 100 can interact with a “margin” on/off button on an user interface relating to a specific customer account for the exchange platform. For example, system 100 can detect that a customer account is operating in “margin mode” (or has an active margin status) which allows the customer to buy and sell, enabling the system 100 to borrow for the specific customer trading activities if necessary. System 100 will not implement trades with additional borrowing if the margin mode is off for a particular customer account. Accordingly, system 100 manages margin modes for each of a plurality of customer accounts to determine if a specific customer account has margin mode activated for on-demand margin lending and borrowing. That is, system 100 can detect, for each of a plurality of customer accounts, if a given customer account is operating in margin mode.

System 100 can selectively activate margin mode for trading accounts, and switch between different trading modes for accounts. In some embodiments, the user interface for a customer account has a button to activate margin mode or deactivate margin mode for the customer account. For example, a node 102 can have a margin application with instructions for a user interface to receive commands regarding a trading account operating in margin mode. In some embodiments, system 100 automatically activates margin mode or deactivates margin mode for the customer account. In some embodiments, the user interface for a customer account has a margin panel that can display margin data relating to the customer account, such as a computed margin values, including expected Incremental Borrow and Total Borrow quantities, for example. System 100 implements margin requirements for each customer account (operating in margin mode) and its associated assets. System 100 can use margin requirements to compute heath statuses or indicators for the trading accounts. Each health indicator corresponds to a set of permitted activities that are codified by system 100 to automatically control trading activities for customer accounts. In some embodiments, system 100 will use different thresholds, such as leverage thresholds to govern trading activities for accounts operating in margin mode. For example, system 100 may not exceed a Maximum Initial Leverage that is set on that trading account by placing an order. Further, system 100 can implement automatic repayment of loans as soon as there are sufficient idle funds in a customer account. Leverage values can be used by system 100 to determine the health indicator of an account, and can monitor health indicators for accounts over time to detect that the health level of an account has changed over the time period. The leverage can be determined by computing margin requirements and margin values for the account. The system 100 compares margin values for the account to the margin requirements to assess risk. The system 100 computes the margin values for the unified trading account using an improved adaptive collateral process. The approach for adaptive collateral is based on statistical analysis of historical trading data to determine the appropriate ratings for the quality of each asset that is accepted as collateral for trading activities for an account. The approach for adaptive collateral analyzes the effect on collateral value (in particular the amount of collateral value decretion or drawdown) in the event that liquidation is required across a range of scenarios and sizes. System 100 implements an enhanced approach to collateral valuation that better assesses (a) the volatility or market risk of an asset and (b) the ability to liquidate such asset to (c) establish prudent haircuts that adapt to (increase) as the amount of asset deposited as collateral increases. In summary: Higher quality (i.e. lower volatility, higher ability to liquidate) assets will continue to receive a higher collateral rating (i.e. lower haircut); Lower quality assets will receive a lower collateral rating that more sharply decreases (higher haircut) as the amount of the asset is deposited (i.e. less recognised value); and Smaller collateral positions will receive a higher collateral rating than larger positions to reflect liquidation capacity.

The system 100 provides on-demand margin services by continuously computing the margin values for the unified trading account and comparing those margin values to the margin requirements to determine a health indicator for the account. The health indicators control what actions or activities an account can take at various margin levels. Example health indicators include: healthy, monitor, caution, danger, critical, and suspended. Each health indicator is associated with a set of permitted activities for automated control of accounts operating in margin mode. Each health indicator can be associated with a set of actions that can be automatically implemented by system 100 upon determining the health indicator for a specific customer account. The set of actions implemented by system 100 can help to automatically improve the health of an account, for example.

In some embodiments, the system 100 can utilize leverage and LTV (Loan To Value) as example risk metrics for the margin requirements. The same ‘Maximum Initial Leverage’ can be applied to all assets, for example. In some embodiments, the system 100 can use different leverage waterfall thresholds for different health levels to assess margin requirements. The system 100 would then take different actions based on the account health level.

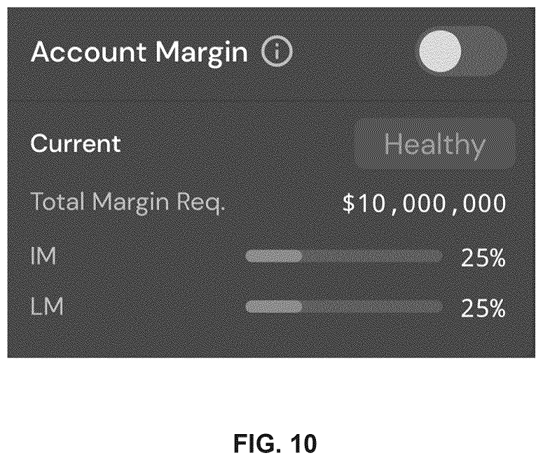

In some embodiments, the system 100 regularly computes margin requirements to assess risk of an account, and to support leveraged trading (e.g. spot and perpetuals) in one unified account. Additionally, in some embodiments, the system 100 can have different maximum leverages for different types of trading. This complexity can make it difficult to maintain simple risk metrics. Therefore, system 100 can transition to measuring risks through comparing margin (for an account or subaccount) against margin requirements. The system 100 can periodically (e.g. every 30 minutes) compute margin for an account (or subaccount) given that the margin values can change with different trading activities. In some embodiments, the system 100 can generate visualizations of the margin values for display at a user interface. In some embodiments, the system 100 can generate visualizations of the margin requirements for display at a user interface. For example, system 100 can generate visual elements that represent Initial Margin Percentage (IM %) and Liquidation Margin Percentage (LM %). IM % measures how much of initial margin a customer has used. LM % indicates how close the customer is to liquidation. In some embodiments, the system 100 can generate different health level metrics. The health level of an account can impact permitted activities for the account. For example, the system 100 can take actions based on the health level. See FIG. 10, for example.

The system 100 can regularly and periodically compute margin values or risk values for the account (e.g. every 30 mins). The actions or activities on the account change as these values changes. The margin values can be used to determine the “health” of the account or estimates that provide indicators for health. System 100 compares the margin of the account and its health estimates to transition between states of the accounts. The health of an account is constantly changing. For example, orders will change the margin values for an account. The health of the account can impact what activities are permitted for the account. For example, if the account is in a monitor state then the account might not be able to take on more leverage.

In some embodiment, distributed system 100 includes a plurality of nodes 102 which can be clients, servers, peers, and so on. The distributed system 100 can utilize computing resources across the nodes 102. The nodes 102 can be physically separate computing resources. In some embodiments, a node 102 has at least one processor 110, memory 120, at least one I/O interface 130, at least one network interface 140, and an application programming interface (API) 150. One or more nodes 102 can include a margin processor, for example.

In some embodiments, a node 102 has memory 120 that stores instructions for different computing applications for on-demand margin borrowing and lending. For example, the computing applications can include a marginer, market maker, matcher, an accountant engine, and a dispatcher. The marginer includes a margin processor and margin data. The margin processor implements margin processing methods for lending, borrowing, interest charge, and so on. The marginer manages and stores all margin lending and borrowing related data for all users of the system 100. The market maker can generate and manage buy and sell prices for assets to execute trading activities. The market maker can be an automated market maker (AMM). The market maker can use a pricing process to calculate prices for assets. The matcher includes a matching engine that can execute transactions and orders by matching a lender and a borrower. The accountant engine implements accounting related functionalities. The dispatcher routes commands and data to different applications. The system 100 can implement margin lending using a liquidity pool.

The system 100 provides on-demand margin lending and borrowing to trade, provides automated repayment to minimize funding, and uses multiple assets as collateral. Consistent with prudent risk management and practices of regulated exchanges, system 100 can apply a collateral rating (which may be referred to as a ‘haircut’) to customers' accounts (including subaccounts) of digital assets (“assets”) that can be used as collateral to support trading activities to reflect the quality of the assets. In practice, for example, a lower rating (e.g. large haircut) can indicate a relatively lower quality asset. System 100 detects when a customer account is in margin mode and computes an associated margin value for trading activities. System 100 computes a margin value for the account. The margin value can involve the collateral rating.

For example, system 100 can enable margin on a subaccount and can use multiple assets as collateral for that subaccount for cross-collateralization of assets. In assessing collateral, the system 100 can consider all assets within a given subaccount as potential collateral to borrow assets in that subaccount (“cross-margin within the account”). In this example, assets in other subaccounts might not be considered for the purpose of calculating margin in a given subaccount (“isolated margin between accounts”).

An approach to collateral considers factors such as liquidity of the asset including the AMM pool size, order depth, and trading volume to generate a single rating for each asset, regardless of the amount of assets deposited. This approach does not adequately consider the risks and likelihood of liquidating varying amounts of assets' accepted as collateral. This can result in, for example, small amounts of collateral posted in a particular asset receiving an overly conservative rating despite demonstrating high liquidity (i.e. ability to readily liquidate) where also larger amounts of collateral posted in a particular asset not incorporating capabilities to readily liquidate (i.e. higher rating than the analysis would support).

In some embodiments, system 100 can use an improved approach to collateral, which may be referred to as portfolio collateral. System 100 integrates portfolio collateral with on-demand margin lending and borrowing.

System 100 can compute collateral using different processes and values. For example, each asset can have a specific multiplier value associated with it (which can be referred to as “Collateral Rating” or “CR”) which determines how much of a nominal value can actually be used as collateral by system 100. As another example, system 100 can use an improved approach to collateral valuation that can better assess (a) the volatility or market risk of an asset and (b) the ability to liquidate such asset to (c) establish prudent haircuts (e.g. collateral ratings) that adapt to (increase) as the amount of asset deposited as collateral increases.

In summary, system 100 uses an improved collateral methodology such that: (i) Higher quality (i.e. lower volatility, higher ability to liquidate) assets will continue to receive a higher collateral rating (i.e. lower haircut); (ii) Lower quality assets will receive a lower collateral rating that more sharply decreases (higher haircut) as the amount of the asset is deposited (i.e. less recognised value); (iii) Smaller collateral positions will receive a higher collateral rating than larger positions to reflect liquidation capacity.

For example, system 100 can use an improved collateral method based on a statistical approach that attempts to cluster currencies or different types of assets (e.g. coins) into tiers and bands so that for each of the different types of assets with different sizes, system 100 defines an associated collateral rating for them.

Regarding integration of portfolio collateral with the margin process, system 100 can compute a margin value for an account as: margin=(collateral−haircut)+futures pnl−debt, where “pnl” refers to profits and losses, and the “haircut” refers to a rating or a collateral rating. System 100 can compute portfolio collateral or a collateral rating. The portfolio collateral will impact the (collateral−haircut) component of the margin computation. For all the different types of assets that clients post as collateral in their accounts, system 100 will use the defined collateral rating to recalculate the dollar amount for each of the different types of assets. This dollar amount can be discounted compared to the spot value of the coins and can be included as margin in the account. The system 100 can then compare the margin value to the margin requirements to determine a health indicator for the account.

Embodiments described herein provide an improved system and process for on-demand margin for trading activities for a plurality of customer accounts that are configured to operate in margin mode. System 100 detects that a particular customer account is operating in margin mode and computes a margin value for that account that involves the improved collateral valuation. The system 100 can compute collateral ratings for different types of assets using a plurality of collateral parameters. The system conducts statistical analysis of historical trading data stored by the system 100 to determine the appropriate ratings for the quality of each asset in an account that is accepted as collateral for trading activities. The system 100 analyzes the effect on collateral value, in particular the amount of collateral value decretion or drawdown, in the event that liquidation is required across a range of scenarios and sizes. The system 100 can conduct this enhanced approach to collateral valuation by selecting the most recent 6-months time period (hourly data) for each asset and randomly selecting 2,400 starting points within that period to serve as the basis for simulating liquidations (liquidation period). For this illustrative example, during this liquidation period, the system 100 generates 2,400 return scenarios, from which the system 100 identifies the 1% worst drawdown (i.e., decretion in value) to determine haircuts across notional amounts. The notional amounts that the system 100 identifies as exceeding the defined amount (i.e., would remain unfulfilled or unliquidated based on the analysis), after this period are assigned a collateral value of zero by the system 100. The resulting collateral value is then determined by the system 100 as a weighted average between filled and unfilled amounts. For example, collateral rating=filled percentage×(1−drawdown)+(unfilled percentage×0), where the second term is only shown for clarity as it always equals zero. The system 100 then repeats this process for every asset accepted as collateral across notional amounts that correspond to each such asset (e.g., ranging from $100 to $200,000,000). The system 100 then groups assets into tiers based on similar profiles based on correlation analysis (e.g. not price return correlation) where correlation value is greater than the defined amount (e.g., 98%). For each tier, the system 100 establishes notional bands that assign an increasing haircut to higher amounts of an asset posted. The bands are based on quantitative results of the system 100 analysis, however also consider qualitative considerations related to liquidation capacity.

The system 100 can use numerous considerations and approaches for parameters of the methodology.

Liquidation Time Period parameter: analysis by the system 100 is based on a 6 hour maximum liquidation time frame. This parameter is based on the likely maximum time period in which assets could be liquidated by the system 100 reliably without causing market disruption and within acceptable values. Where the posted amount exceeds such defined maximum amount, such amount will receive a 100% haircut (i.e., no recognized value) by the system 100.

Lookback Period parameter: analysis by the system 100 applies a 6 month recent data approach to (a) account for changes in AMM strategy and (b) consider recent trading volume to reflect current market sentiment. In addition, a historical material stress event is also considered by the system 100 to account for extreme but plausible volatility that may impact and/or be beyond quantitative results of the analysis.

Confidence Interval parameter: analysis by the system 100 applies a min. 99% confidence interval (CI), thereby applying the first-percentile worst-case scenario return to determine the haircut for defined notional amounts. This analysis by the system 100 contemplates an extreme, worst-case scenario where the risk waterfall has failed (i.e., corrective actions are not successful or not able to perform due to a system outage), leading to the need to fully liquidate an entire collateral portfolio by the system 100. Applying a 99% CI, indicates that 99% of the time, the actual market impact (i.e., haircut) will be less than the value given.

Trading Volume/Concentration parameter: analysis by the system 100 conservatively assumes that during the modeled liquidation, such account will be 50% of the trading volume at the exchange, while the system 100 is liquidating the positions. This analysis seeks to model the worst-case the system 100 calculates that the two largest customers of the exchange are being liquidated simultaneously and further that such accounts account for approximately 50% of total volume traded over the liquidation period.

Stress Event parameter: analysis by the system 100 considers an extreme but plausible market event, whereby a “worst-case 24h” scenario is incorporated into the system 100 dataset (e.g., exceeds market moves in the selected data set). For this scenario, the most significant one-day drawdown of Bitcoin, Nov. 9, 2022, corresponding to the FTX bankruptcy, can be selected. When the system 100 doesn't have trading data from a given period, such at the period corresponding to the FTX bankruptcy, historical data from another exchange (e.g., Coinbase) can be utilized by the system 100 as a benchmark enabling the system 100 to simulate the relative price changes and volume distribution that would likely occur on the system 100. The methodology used by the system 100 inserts this scenario (market move) into the 6 month lookback period.

New Assets parameter: if there is no available historical data on the system 100 for a new asset, but there exists an liquidity arrangement active for the system 100, an AMM-based approach will be utilized by the system 100 to predict trading volumes and establish appropriate tiers/bands with further qualitative considerations until such time that sufficient historical trading data is available to perform the full margin collateralization analysis. For initial coin offerings (ICOs) and other assets where no trading data available for the system 100 and no arrangements are in place that provide confidence on trading volumes, the system 100 would assig a material haircut (e.g., near to or 100%, materially low band notional value) to such assets until there is sufficient basis to provide greater recognition.

Data Reference parameter: liquidation of non-stable assets (e.g., coins) are calculated by the system 100 to take place in the most liquid AMM pool—for example, BTC liquidations take place in BTCUSDC pool. Liquidations of stable coins are calculated by the system 100 to take place in a combined AMM pools where such stablecoin acts as the quote currency in the pool—for example, USDC liquidations by the system 100 can take place simultaneously across BTCUSDC, ETHUSDC and other USDC associated AMM pools.

The analysis by the system 100 utilizes asset prices and trading volume sourced from Coin Metrics (e.g. accessed via the system 100 API). The resulting data sets are incorporated in the system 100 based on the methodology and parameters to the quantitative risk approach commonly referred to as, R, as the analytical approach for risk assessment.

The following table shows example tiers and bands (at 6 hours liquidation 50% volume stress):

| | | | Collateral |
|---|---|---|---|
| Tier Assets | Bands | USD Notional | Ratio |
| USD | 1 | 1,000,000,000 | 100% |
| | | | Collateral |
| Tiers Assets | Bands | USD Notional | Ratio |
| USDC | 1 | 20,000,000 | 100% |
| | 2 | 50,000,000 | 91% |
| | 3 | 80,000,000 | 81% |
| | 4 | 100,000,000 | 74% |
| | 5 | 120,000,000 | 45% |
| BTC, ETH, WBTC, WEETH | 1 | 100,000 | 100% |
| | 2 | 9,000,000 | 98% |
| | 3 | 20,000,000 | 90% |
| | 4 | 30,000,000 | 75% |
| | 5 | 40,000,000 | 50% |
| USDT | 1 | 1,000,000 | 100% |
| | 2 | 5,000,000 | 90% |
| | 3 | 7,000,000 | 74% |
| | 4 | 10,000,000 | 61% |
| | 5 | 12,000,000 | 45% |
| XRP | 1 | 60,000 | 100% |
| | 2 | 1,000,000 | 96% |
| | 3 | 3,000,000 | 73% |
| | 4 | 4,000,000 | 49% |
| | 5 | 5,000,000 | 36% |
| AVAX, DOGE, UNI, LINK, | 1 | 10,000 | 97% |
| AAVE, LTC, MATIC, SOL | 2 | 200,000 | 86% |
| | 3 | 300,000 | 70% |
| | 4 | 400,000 | 57% |
| | 5 | 500,000 | 45% |
| PYUSD | 1 | 50,000 | 100% |
| | 2 | 200,000 | 91% |
| | 3 | 250,000 | 84% |
| | 4 | 300,000 | 72% |
| | 5 | 400,000 | 65% |
| SAND, SUSHI, BCH, NEAR, | 1 | 1,000 | 97% |
| MANA, CHZ, EOS, GRT, | 2 | 100,000 | 88% |
| CRV, LRC | 3 | 125,000 | 62% |
| | 4 | 150,000 | 54% |
| | 5 | 175,000 | 47% |
| GALA, TRX, DOT, APE, FTM* | 1 | 100 | 97% |
| | 2 | 20,000 | 92% |
| | 3 | 30,000 | 79% |
| | 4 | 40,000 | 66% |
| | 5 | 60,000 | 61% |
| PAXG* | 1 | 100 | 58% |
| | 2 | 1,000 | 54% |
| | 3 | 10,000 | 30% |
| | 4 | 15,000 | 14% |
| | 5 | 20,000 | 5% |
| ADA, OP, XLM, ARB, CD20, | 1 | 0 | 0% |
| ETHFI | | | |

Accordingly, the system 100 provides an improved processing for automatically managing accounts operating in margin mode to provide unified trading accounts. The system 100 uses an improved process for computing margin values and collateral ratings for accounts. The system 100 can use the following parameters for computing collateral ratings: Liquidation Time Period; Lookback Period; Confidence Interval; Trading Volume and Concentration; Stress event; New assets; and historical data.

The system 100 combines best-in-class cross-collateralization with a single account that provides an improved user interface for spot trading, margin trading, and for trading perpetual markets, all with varying leverages. The system 100 can consider margin as a customer's “margin of safety” regarding leveraged trading. A larger margin value can be desirable as it results in an increased ability to withstand large price movements before liquidation. A customer's account's margin s equal to their account's collateral value minus the value of its debts, both measured in USD (Margin=Collateral Value−Debt). To calculate margin the system 100 incorporates idle balances, assets locked in open orders, and unsettled profits or losses. The system 100 calculates debt as simply the current valuation of the assets a customer has borrowed, plus any residual unsettled losses that cannot be offset against a customer's accounts' available balances.

The multiple margin requirements of the system 100 correspond to varying degrees of leverage. The system 100 constantly recalculates and compares a customer's account's margin to the various margin requirements of the system 100 to determine account status, which is also displayed as a health indicator. The status also determines whether any actions need to be taken by the system 100 automatically on the customer's behalf. For example, when a customer's margin falls below a Warning Margin Requirement, the system 100 can automatically update the status to Caution and send a Margin Call notification.

The system 100 can calculate margin requirements for a trading account from the combination of the account's assets borrowed through the system 100 margin service, perpetual positions, perpetual limit orders, perpetual AMM Instructions, and unsettled perpetual losses. The combination of Margin Requirement purpose (e.g., Initial Margin) and product being traded (e.g., Perpetuals) determines a specific leverage value for the system 100 to use in the Simple Margin Requirement formula (Simple Margin Requirement=USD Notional Value/(Leverage−1)). For example, a spot margin trade with a notional value of US$100 at leverage 3× would have a Margin Requirement of US$100/(3−1)=US$50. Similarly, a long or short perpetual market position with a notional value of US$100 at leverage 7× would have a Margin Requirement of US$100/(7−1)≈US$17.

To determine a specific Margin Requirement for the trading account the system 100 adds up the Spot Margin Requirements (using that requirement's spot leverage) and the Perpetual Margin Requirements across all contracts (using that requirement's perpetuals leverage). The spot Margin Requirement is the sum of the individual Simple Margin Requirements for everything that the account has borrowed. This includes any potential borrows from unsettled P&L.

To calculate the Margin Requirement for perpetual contracts, the system 100 consider both bullish (up only) and bearish (down only) market scenarios, and take the largest Simple Margin Requirement of each scenario. In the bullish scenario, the system 100 calculates a net quantity by subtracting short order quantities and AMM Instruction short quantities from the current position. We then price this net quantity using the highest value among the Mark Price, limit order prices, and AMM Instruction upper bound prices. In the bearish scenario, the system 100 calculates a net quantity by adding long order quantities and AMM Instruction long quantities to the current position. The system 100 prices this net quantity using the current Mark Price. The system 100 compares the absolute values of these two notional values and choose the larger one as the worst-case perpetuals position notional. The system 100 converts this notional value to USD for use in the Simple Margin Requirement formula (so the system 100 divides it by (leverage−1)) to determine the overall Margin Requirement for that contract. By summing up the Margin Requirements for all perpetual contracts, the system 100 can determine the final Perpetual Margin Requirement for the trading account at that time.

Each perpetual contract in a trading account has an “unsettled P&L” that represents the combined profits or losses from market price movements, realized trading profits or losses, and Funding Amounts since the last settlement. This unsettled P&L can be netted by the system 100 across contracts by their settlement currency, resulting in a single unsettled profit or loss for the entire trading account per settlement asset. Then the system 100 considers each of the settlement assets and their net unsettled P&L. Unsettled profits will increase the account's collateral value as if they have been added to the available balance for that settlement asset, thereby increasing Margin. Conversely, net unsettled losses will decrease the available balance for that settlement asset by the available amount, decreasing Margin. Further, if the available balance is still insufficient to cover the losses, it will act like a borrow of the settlement asset for the remaining amount, thus both decreasing Margin and increasing the Margin Requirement. Further details regarding perpetuals is provided in U.S. Application No. 63/603,608 entitled COMPUTER SYSTEMS FOR PERPETUAL FEATURES, the entire contents of which is hereby incorporated by reference.

System 100 provides a plurality of customer accounts. Each customer account is a unified account that handles the margin requirements for both spot (margin) and perpetuals (derivatives) activities. System 100 provides an improved adaptive collateral system (with risk) to give some credit (but not too much) to customers. This allows customers to trade in a capital efficient manner as all assets in the account can be used for collateral and leveraged for trading activities. The system 100 can use the entire value of all assets in a single account for trading activities. The system 100 computes a margin value for a customer account and compares that margin value to margin requirements. The system 100 uses an adaptive collateral approach that continuously computes margin and collateral values that are used to compute “margin” of the account (and then continuously compares to margin requirements). The system 100 uses margin requirements as an improved risk model. The system 100 uses health indicators to govern what actions an account can take at various margin levels. The customer account can be referred to as a “Unified Trading Account” and the system can evaluate its corresponding risk by comparing Margin for an account, to various Margin Requirements. The comparison result determines the Account Health. There are different Margin Requirements for different risk levels. For example, if the Margin value is greater than the given Margin Requirement value, then the account has sufficient Margin for that purpose. However if Margin is less than a given value, the account status is updated correspondingly and actions will be taken.

The I/O interface 130 enables the system 100 to interconnect with one or more input devices, such as a keyboard, mouse, camera, touch screen and a microphone, or with one or more output devices such as a display screen and a speaker. The network interface 140 enables the system 100 to communicate with other components, to exchange data with other components, to access and connect to network resources, to serve applications, and perform other computing applications by connecting to a network 170 (or multiple networks, or a combination of different networks) capable of carrying data. The hardware components of the system 100 may be connected in various ways including directly coupled, indirectly coupled via a network, and distributed over a wide geographic area and connected via a network (which may be referred to as “cloud computing”). For example, and without limitation, the system 100 may be a server, network appliance, embedded device, computer expansion module, or other computing device capable of being configured to carry out the methods described herein. Memory 120 can be distributed storage devices for a blockchain infrastructure or web applications. The system 100 has distributed memory of nodes 102 to provide blockchain infrastructure.

The system 100 connects nodes 102 to exchange data and commands. In some embodiments, a node 102 can be implemented by an electronic device with memory storing instructions for a margin application and one or more processors that execute the instructions and the margin applications. The memory can store instructions for the margin application to generate one or more user interfaces to exchange data with other nodes 102 of the system 100. The margin application can provide a user interface to display output and receive input for on-demand margin lending and borrowing. There can be different types of user interfaces, such as an administrator interface, a borrower interface (or trader interface), and a lender interface. The margin application has an interface to provide visualizations of data received from other nodes 102 of the system 100.

The system 100 provides on-demand margin borrowing and lending where one client (e.g., using node 102) can lend a loan to another client (e.g., using another node 102). The client that lends the loan can be referred to as a lender, and the other client that receives the loan can be referred to as a borrower. Lenders (or asset holders) can earn an income on their idle assets in a regulated environment and request repayment terms. Borrowers want to borrow assets for variable periods of time efficiently and cost effectively.

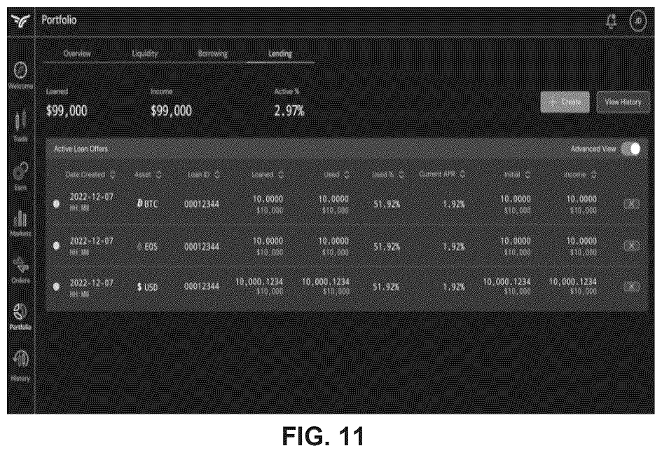

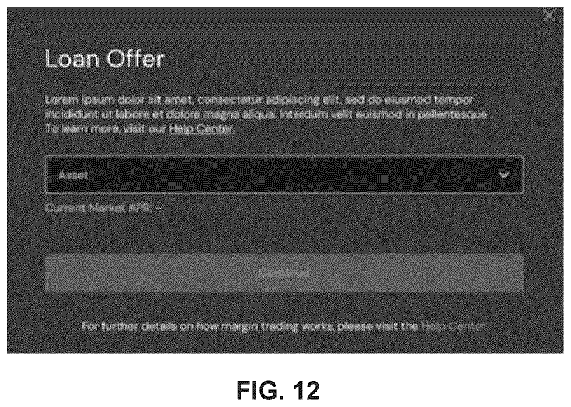

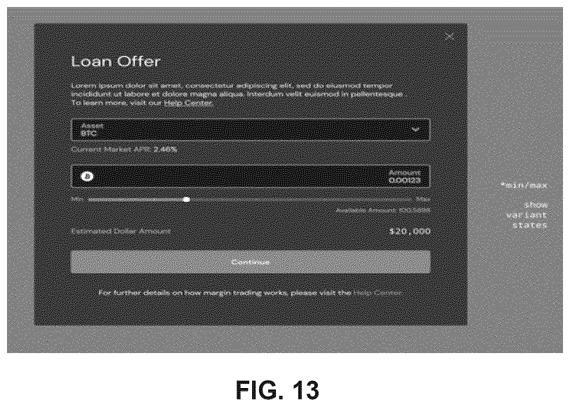

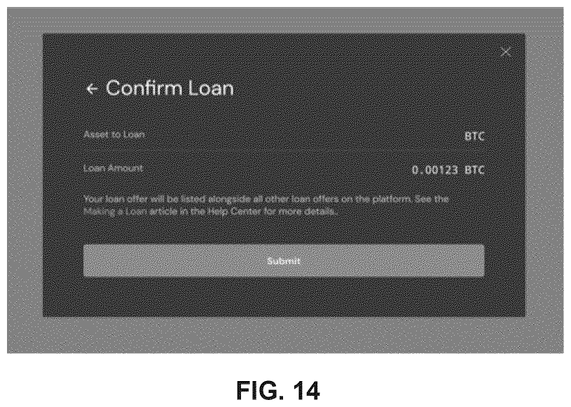

Accordingly, clients or customers of system 100 may be borrowers or lenders. In some embodiments, there can be two customer types: (1) Institutional and/or Accredited investors, and (2) Retail. The example embodiments described here may only relate to the first type of customer, Institutional and/or Accredited investors, but other example embodiments may involve retail customers. In some embodiments, there can be three categories of users: (1) Appointed Representatives, (2) Traders, and (3) Investors/Lenders. There are typically one or more Appointed Representatives that can be system administrators for institution accounts, corporate administrators, and/or traders (e.g., if the customer is a small company). At a high level, the user journey for Appointed Representatives is: (a) enable margin for a specific subaccount, (b) change the maximum initial leverage to a specific value on a specific subaccount, (c) disable margin for a specific subaccount, and (d) see the current and recent rates for borrowing specific assets. Traders consist of borrowers who trade for specific intuitions based on the policies that have been granted for them. At a high level, the user journey for Traders is: (a) buy or sell as asset by borrowing USD or the asset as necessary, on demand, (b) understand the implications of the Trader's ongoing liabilities of taking on additional debt, (c) automatically repay debts with idle assets, and (d) understand how much the Traders have recently been paying to service debts. Investors/Lenders consist of lenders/customers of the exchange who want to generate returns on idle assets. At a high level, the user journey for Investors/Lenders is: (a) understand what returns are possible and how much capacity (demand) there is currently, (b) generate returns from idle assets by making a loan offer to borrowers, and (c) understand the returns being generated from loan offers, individually and in aggregate. There can be one or more Appointed Representatives that can be system administrators for institution accounts or a corporate administrator. The Appointed Representative can also be a trader (e.g., if the customer is a small company). Appointed Representatives create new accounts, onboard new users, and give permissions/trading policies to accounts or onboarded users. Appointed Representatives can be linked to one or more traders or one or more investors/lenders. Traders can trade for specific institutions based on the policies that have been granted to them. Traders can be borrowers. Borrowers can borrow assets from Investors/Lenders. Investors can be lenders that are customers of the exchange and want to generate returns on idle assets held by the investor. The exchange platform (i.e., the system 100) can be the agent for the lender. FIGS. 11 to 14 illustrate the high level user journey for loan creation for each category of user described. FIG. 11 depicts the lender interface for a loan creation. FIGS. 12-14 show the sequential screens the lender will be shown in order to finalize the loan creation.

In some embodiments, the system 100 provides an exchange platform that connects electronic devices (e.g., nodes 102) to buy, sell and trade assets or currencies (e.g., cryptocurrencies) using smart contract code to control exchange commands on blockchain platforms. The system 100 or exchange platform can use a pricing process that can involve a new hybrid order book integrating an automated market maker (AMM) with a central limit order book. A central limit order book is a trade execution model based on a system that matches customer orders (bids/bid orders and offers/asks) on a price and/or time priority basis. The hybrid order book involves a matching engine. An AMM can use a formula to calculate the rate or price, and does not use a central limit order book for the rate or price as used for a traditional exchange. Cryptocurrencies are priced according to a pricing process calculated using the AMM. Further details are provided in International Application No. PCT/US2022/038593 entitled TRADING PLATFORM INTEGRATING AUTOMATED MARKET MAKER AND ORDER BOOK, the entire contents of which is hereby incorporated by reference.

The system 100 can involve different software and hardware components implemented using equipment and code, including smart contracts. The system 100 or exchange platform can use blockchain infrastructure for implementing decentralized, distributed on-demand, peer-to-peer margin lending or borrowing. Embodiments described herein relate to an exchange platform with smart contract code programmed to execute margin lending or borrowing transactions and trades on the blockchain infrastructure.

The system 100 sets leverage threshold values for each individual subaccount. Each user or customer of the system 100 can have multiple subaccounts. The system 100 can generate a borrower interface to receive data on a Borrower's leverage, including a Borrower's current leverage and margin ratio values. In situations where a Borrower's leverage increases past a safety threshold, The system 100 will prevent additional risk from being added and start to unwind positions, stopping when the safety threshold is no longer an issue. The client can adjust the safety threshold based on their preferences.

The system 100 processes requests to buy or sell assets. A borrower interface can transmit the request to buy or sell assets to the system 100. Such a request to buy or sell an asset can be fulfilled by the system 100 by borrowing currency or borrowing the asset on demand. The system 100 can also determine liabilities and charges for taking on additional debt.

The system 100 can process a loan offer to generate returns from idle assets. A lender interface can transmit the loan offer request to the system 100. A lender may submit the loan offer to the lender interface to generate returns from idle assets. The system 100 can compute return data and demand/capacity data for an individual loan offer, or for an aggregate of loan offers. A lender can specify an interest rate when inputting loan instructions to create a loan offer. The system 100 can then provide the loan offer to a borrower interface. The system 100 can prioritize a loan offer for a borrower in various ways. For example, a loan offer can be prioritized based on interest rate (to give the borrower a lower rate) and then a loan offer timestamp, or solely based on a loan offer timestamp. The system 100 can prioritize a borrower for a loan offer based on a timestamp. The system 100 can use other parameters as weightings to prioritize lender and borrower matching.

An example of the system 100 prioritizing a loan offer for a borrower based on loan offer timestamp follows, in chronological order: (a) Lender A puts in a loan instruction for 1 BTC to create a loan offer that sits in a loan book in the system 100 as available for borrowing; (b) Lender B puts in a loan instruction for 2 BTC to create a loan offer that sits in a loan book in the system as available for borrowing; (c) Borrower A wants to borrow 1.5 BTC and the system 100 fills against the 1 BTC from Lender A and 0.5 BTC from Lender B, with the system 100 marking the full 1 BTC from Lender A as currently unavailable to other borrowers, and 0.5 BTC from Lender B as currently unavailable to other borrowers.

The system 100 can determine rates for assets. For example, the system 100 can compute current and recent rates for borrowing specific assets.

The system 100 can execute a margin transaction between a borrower and a lender. System 100 can implement automated repayment of debts or loans with idle assets of a trader, for example.

The system 100 has a memory 120 storing historical trading data and instructions for a plurality of customer accounts, each customer account being a unified trading account. The system 100 has a hardware processor 110 executing instructions to provide a margin processor configured to provide margin operations for the plurality of customer accounts for on-demand margin lending, on-demand margin borrowing, and interest charges. The margin processor: determines that the customer account is operating in a margin mode to use assets on-demand for trading activities. The computer system 100 uses assets in the customer account as collateral for the trading activities. The computer system 100 continuously computes a margin value for the customer account based on a collateral rating for the assets in the customer account used as collateral for the trading activities, wherein the collateral rating reflects a quality of the assets in the customer account based on a statistical analysis of historical trading data to determine, for each type of the assets in the customer account, a quality rating for a respective type of the asset in the customer account as an assessment of volatility or market risk of the asset in the customer account and an ability to liquidate the asset in the customer account. The collateral rating is adapted to change proportionally with a value of the assets in the customer account. The computer system 100 automatically controls the trading activities for the customer account operating in the margin mode using the continuously computed margin value for the customer account. The computer system 100 connects to a node 102 with a margin application providing a margin interface that outputs one or more visual elements corresponding to at least a portion of the margin value for the customer account operating in the margin mode, and updates the one or more visual elements as the margin value is continuously computed.

In some embodiments, the margin processor sets one or more margin requirements for the customer account, and continuously compares the margin value for the customer account to the margin requirements to evaluate risk for the customer account, wherein the margin processor controls the trading activities for the customer account operating in the margin mode using the one or more margin requirements. For example, trading activities may impact the margin value and the system continuously computes the margin value to reflect the various trading activities over time and compares the margin value to the margin requirements for continuous monitoring and control of the account and trading activities.

In some embodiments, the margin processor computes a health indicator for the customer account based on the margin value and the margin requirements, the health indicator corresponding to one or more permitted actions for the customer account. The computer system 100 executes code to control activities for the customer account using the one or more permitted actions corresponding to the health indicator for the customer account.

In some embodiments, upon determining that the margin value for the customer account does not meet the margin requirements for the customer account, the margin processor updates the one or more permitted actions for the customer account, wherein upon receiving a request for an activity for a customer account. The computer system 100 verifies the one or more permitted actions corresponding to the health indicator for the customer account before implementing the requested activity. Wherein upon determining that the requested activity is not include in the one or more permitted actions corresponding to the health indicator for the customer account, the computer system 100 rejects or permits the request for the activity for the customer account.

In some embodiments, the margin processor computes the collateral rating for the assets in the customer account used as collateral for the trading activities by discounting a normalized value of all types of assets in the customer account by a rating reflective of a quality measure of the assets in the customer account. A higher quality asset will have a higher rating and lower haircut, and a lower quality asset will have a lower rating and higher haircut.

In some embodiments, the margin processor computes the collateral rating for the assets in the customer account as collateral value-haircut, wherein the collateral value is a normalized value of the assets in the customer account and a haircut reflects a quality measure of the assets in the customer account, wherein a higher quality reflects a lower haircut, and a lower quality reflects a higher haircut.

In some embodiments, the margin processor computes the margin value for the customer account as: margin=(collateral value−haircut)+futures pnl−debt.

In some embodiments, The computer system 100 has a dispatcher, a matcher, a marginer, a market maker, and an accountant engine to implement one or more of the trading activities for the customer account.

In some embodiments, the margin processor: enables margin trading on a subaccount; sets margin requirements for the subaccount; processes a loan request to buy or sell an asset from a borrower interface; processes a loan offer to generate returns from idle assets from a lender interface; determines rates for assets in the customer account; executes a margin transaction between the borrower interface and the lender interface, the margin transaction being smart contract code for a blockchain infrastructure; and computes different types of margin data, and generates output for transmission, storage or display at the margin interface.

In some embodiments, the margin processor is further configured to automatically update the one or more visual elements of the margin interface using output data relating to a margin transaction, the one or more visual elements indicating a risk value for the margin transaction and the margin requirements for a subaccount.

In some embodiments, the computer system 100 has a liquidation engine configured to process automatic de-leveraging of a subaccount, wherein the liquidation engine automatically liquidates assets in the subaccount when a leverage threshold value of the subaccount is above a safety threshold value.

In some embodiments, the safety threshold value is at least one of: a default value; and an adaptive value configured by the computer system in response to continuously computing the margin value and comparing to the margin requirements.

In some embodiments, the liquidation engine is further configured to set a liquidation price of an asset held in the subaccount.

In some embodiments, output data relating to a margin transaction includes an impact of a planned margin transaction, wherein the impact of the planned margin transaction is determined by the margin processor and the impact of the planned action is at least one of: additional assets that will be borrowed as a result of the planned margin transaction; a total of the additional assets that will be borrowed as a result of the planned margin transaction; an asset price at which a user will lose control of the subaccount to the liquidation engine as a result of the planned margin transaction; an expected leverage of the subaccount as a result of the planned margin transaction; expected fees as a result of the planned margin transaction; and an expected notional as a result of the planned margin transaction.

In some embodiments, the margin processor is further configured to automatically process repayment of at least one loan of the subaccount by selling idle assets of the subaccount, wherein the margin processor is configured to determine the at least one loan by calculating the at least one loan with the highest loan rate.

In some embodiments, the margin processor is further configured to automatically processes a repayment of the at least one loan of the subaccount at a regular interval.

In some embodiments, the margin processor is further configured to process loan return data and loan capacity data for at least one of: an individual loan offer; and an aggregate of loan offers.

In some embodiments, the margin processor uses open order collateral assets in the subaccount for cross-collateralization, wherein the margin processor is further configured to set a leverage characterization status of the subaccount, the margin processor processing a current leverage value of the subaccount and a leverage threshold value of the subaccount to set the leverage characterization.

In some embodiments, the health indicator comprises a status selected from the group of healthy, monitor, danger, critical, and suspended.

In some embodiments, the margin interface further comprises a margin toggle configured to activate or deactivate the margin mode.

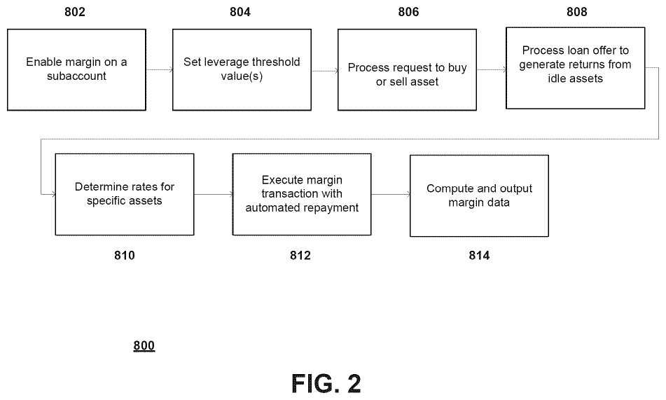

FIG. 2 shows a diagram of a process for on-demand margin borrowing and lending according to embodiments described herein. The system 100 can implement different operations relating to on-demand margin borrowing and lending. The operations shown in FIG. 2 are examples only and other operations may also be implemented by the system 100 for on-demand margin borrowing and lending. Further, the example operations shown in FIG. 2 are not limited to a specific order of operations, and the operations are arranged in an example process flow to illustrate different functionality of the system 100.

At 802, the system 100 enables margin on a subaccount for cross-collateralization of assets. The system 100 can activate margin mode for an account or sub-account. In some embodiments, a user interface can receive commands for system 100 to enable margin for a subaccount. The system 100 can also disable margin on the subaccount. The system 100 can receive commands from a user interface (e.g., an administrator interface at a node 102) to enable/disable margin on the subaccount. A trader or borrower can enable margin on any subaccount and benefit from cross-collateralization of all their assets, even those locked in limit orders, for maximum capital efficiency.

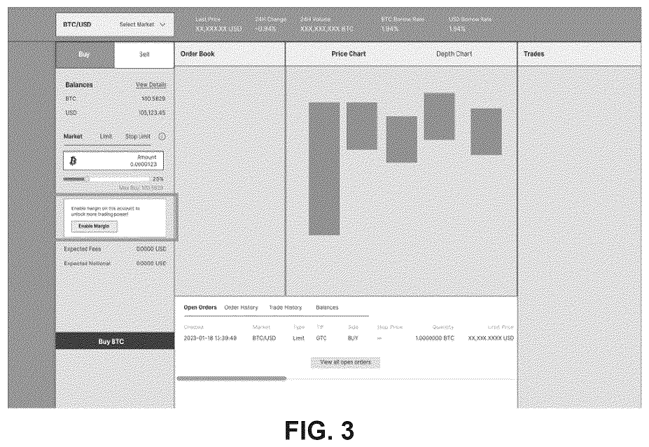

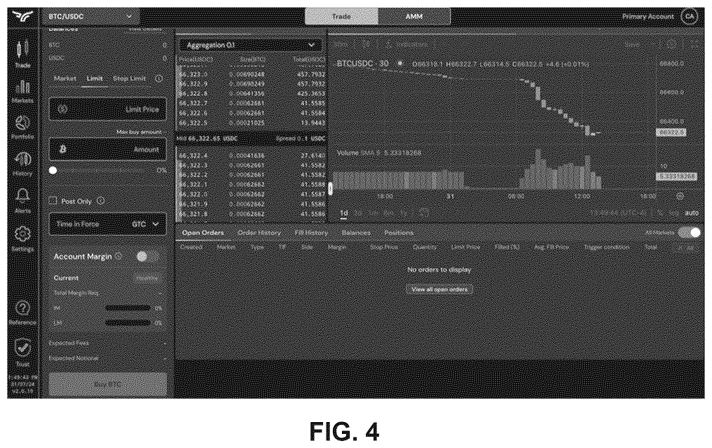

FIG. 3 shows an example user interface with selectable indicia to trigger a request for system 100 to enable margin on a subaccount. FIG. 4 shows another example user interface with selectable indicia to trigger a request for system 100 to enable margin on a subaccount.

In the illustrative example in FIG. 4, the order entry panel is set to 54%. The electronic slider has three markers for 25%, 50% and 75%, however, the dot can be moved to any value between 0% and 100% (within the minimum and maximum buy/sell amounts). The position of the dot on the slider reflects the order amount relative to the maximum buy/sell amount. As the user slides the slider, the order amount auto-fills, alternatively, if the user enters an order amount, the dot moves along the slider automatically. If the order amount entered is less than the minimum order size, the dot will stay at the far left of the slider and an error message is displayed to the user via a user interface. The value range set on the slider represents the minimum and maximum size for orders being placed for that specific market through that specific subaccount. These are illustrative, non-limiting examples.

FIG. 4 shows margin characteristics and functionality for buying crypto including the Margin toggle and Margin data panel. The Margin toggle and Margin data panel are displayed only when Margin terms and conditions are accepted and Leverage is set. The user can switch the Margin toggle on and off to control whether to allow auto-borrow to trade (increase leverage) when there is not sufficient buying power to place an order (in this example, the Margin toggle is encased in a red box for visibility). The Margin data panel (depicted below the Margin toggle) remains the same regardless of whether Margin toggle is on or off. The Margin data panel is not affected by the user switching the margin toggle on or off.

In FIG. 4, the Margin data panel contains information pertaining to Current Leverage, Incremental Borrow, Total Borrow, Liquidation Price, Expected Leverage, Expected Fees and Expected Notational. Incremental Borrow refers to the extra amount that will be borrowed as a result of the intended order. The Incremental Borrow value updates after the user enters an order amount to show the impact of a planned action. Incremental Borrow has two states, Current and Expected. The value when in Current state should always be 0. Total Borrow refers to the total borrowed value of the relevant asset. The Incremental Borrow value updates to the Expected state after the user enters an order amount to show the impact of a planned 32ctionn. Total Borrow has two states, Current and Expected. The value when in Current state should be the existing borrowed balance of the relevant asset. The Total Borrow value updates to the Expected state after the user enters an order amount to show the impact of a planned action. Liquidation Price refers to the price at which the system 100 projects that the customer will lose control of the subaccount to the liquidation engine. Expected Leverage updates after the user enters an order amount to show the impact of a planned action. In this example, the Expected Leverage is 2.81×. The Expected Fees and Expected Notational are shown in USD as an example currency. The system 100 can support other currencies for display in the Margin data panel. The system 100 can have a main or default currency, such as USDC, and a user can configure the display currency for their account as per user preference.

The table below shows the formula on the buy and sell sides for Incremental Borrow, Total Borrow, and Leverage.

In FIG. 4, the Balances tab depicted near the bottom of FIG. 4 depicts columns with the headers: Assets, Net, Holdings, Idle, and Borrowed. Assets refers to the specific asset available, in this example it is BTC. Net refers to the quantity of total holdings net of borrowed, and the formula is HoldingSₐₛₛₑₜ−ActiveBorrowₐₛₛₑₜ. Holdings refers to the quantity of assets in the account, regardless of the asset state and the formula is Holdingsₐₛₛₑₜ. Idle refers to the quantity of assets that are free to use and is calculated by IdleBalanceₐₛₛₑₜ. Borrowed refers to the quantity of borrowed assets and the formula is ActiveBorrowₐₛₛₑₜ. The system also depicts Net, Holdings, Idle and Borrowed in USD representing the respective USD value. This is calculated by multiplying the respective formula by Pₐₛₛₑₜ. The currency displayed by the system 100 can be any currency. For example, the system 100 can have a main currency (e.g., USDC) which can be configured by a user using an interface to be different currencies. Example currencies include, but are not limited to, BTC, USD, USDC, ETH, and USDT.

The system 100 checks the modes for the multiple customer accounts for determining that a customer account is operating in a margin mode to borrow assets on-demand for trading activities. The system 100 automatically uses assets in the customer account as collateral for the trading activities upon determining that the customer account is operating in the margin mode.

The system 100 continuously computes a margin value for the customer account based on a collateral rating for the assets in the customer account used as collateral for the trading activities. The collateral rating reflects a quality of the assets in the customer account based on a statistical analysis of historical trading data to determine, for each type of the assets in the customer account, a quality rating for a respective type of asset in the customer account as an assessment of volatility or market risk of the asset in the customer account and an ability to liquidate the asset in the customer account. The system 100 adapts the collateral rating to change proportionally with a value of the assets in the customer account.

Referring back to FIG. 2, at 804, the system 100 sets margin requirements for an account, which may include leverage threshold values for the subaccount. For example, the system 100 can change maximum initial leverage to a specific value on a specific subaccount. The maximum initial leverage determines the largest amount that can be borrowed relative to collateral before the system 100 prevents the user from increasing their risk further by borrowing more. Embodiments described herein provide improved processes and machines for managing collateral for the system 100.

The system 100 can automatically control the trading activities for the customer account operating in the margin mode using the continuously computed margin value for the customer account and the margin requirements. The system 100 can outputting, at a margin interface, one or more visual elements corresponding to at least a portion of the margin value for the customer account operating in the margin mode, and update the one or more visual elements as the margin value is continuously computed.

The system 100 can implement automated de-leveraging using a configurable safety threshold. For example, the safety threshold can be based on margin requirements. In situations where the leverage increases past a safety threshold that the client can adjust based on their preferences, the system 100 will intelligently and automatically prevent additional risk from being added and then automatically start to unwind positions, stopping when the safety threshold is no longer an issue. This functionality avoids the feedback loops that cause unwanted price deviations and unnecessary liquidations seen on some other exchanges and platforms, which a significant improvement over those other exchanges and platforms. FIG. 4 shows an example user interface displaying current leverage. The system 100 can compare the current leverage to the leverage threshold values (including the safety threshold) to generate output data characterizing the leverage to automatically update the interface. In this example of FIG. 4 the interface indicates that the leverage is ‘healthy’. The leverage threshold values are configurations of the system 100 set on the backend.

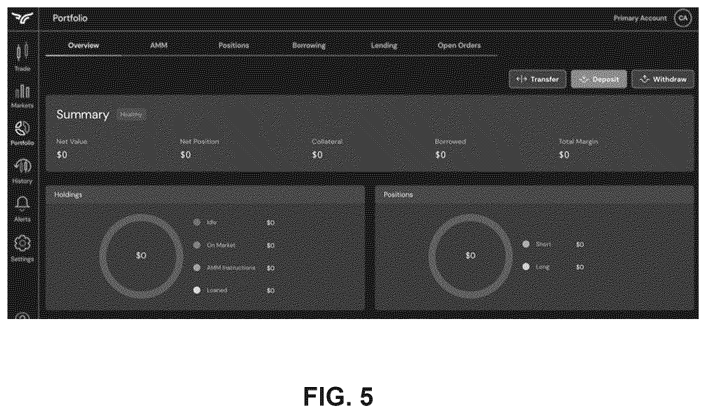

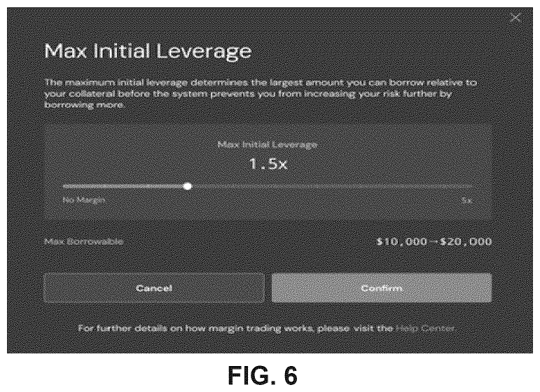

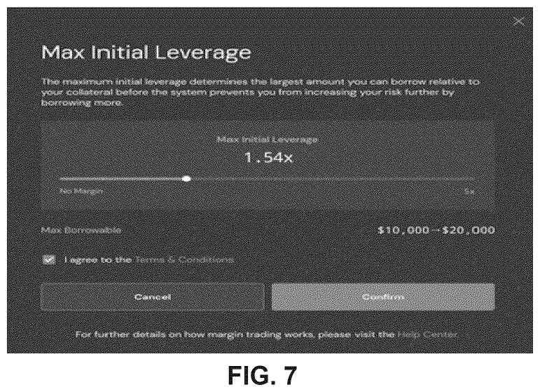

FIG. 5 shows an example user interface with selectable indicia to edit or configure a leverage threshold value. In this example, the maximum initial leverage is 2.5×. FIG. 6 shows an example user interface with selectable indicia to edit or configure a leverage threshold value between no leverage and 5×. In this example, the maximum initial leverage is 1.5×, and a user can configure the maximum initial lever to be lower at the interface. The user interface also indicates a maximum borrowable range of $10,000 to $20,000. FIG. 7 shows an example user interface with selectable indicia to edit or configure a leverage threshold value between no leverage and 5×. In this example, the maximum initial leverage is 1.54×, and a user can configure the maximum initial leverage to be lower at the interface. The user interface also indicates a maximum borrowable range of $10,000 to $20,000. The system 100 determines the maximum borrowable range based on a borrower's collateral. The system 100 can also implement a risk-based process to calculate the maximum borrowable range. The risk-based approach can include the system 100 analysing risk on the portfolio level, rather than the subaccount level. This may let a user borrow more, if the risk analysis on a portfolio allows more borrowing than a collateral/leverage calculation.

At 806, the system 100 can process a request to buy or sell an asset. A borrower interface can transmit the request to buy or sell the asset to the system 100. The request to buy or sell an asset can be by borrowing currency or the asset on demand. The system 100 can also determine liabilities and charges for taking on additional debt.

At 808, the system 100 can process a loan offer to generate returns from idle assets. A lender interface can transmit the loan offer request to the system 100. A lender may submit the loan offer to the lender interface to generate returns from idle assets. The system 100 can compute return data and demand/capacity data for an individual loan offer, or for an aggregate of loan offers. The system 100 can then provide the loan offer to a borrower interface.

At 810, the system 100 can determine rates for assets. For example, the system 100 can compute current and recent rates for borrowing specific assets.

At 812, the system 100 can execute a margin transaction between a borrower and a lender. The system 100 can implement automated repayment of loans. The system 100 can implement automated repayment of debts or loans with idle assets of a trader, for example. A lender can also automatically receive the benefit of higher rates during periods of high demand without needing to adjust the requested rate, making the loan creation process far simpler. Loans can be terminated and funds returned to the account within defined time periods, making the system 100 an excellent venue to put idle assets to work. The system 100 sets the time periods, but the time periods can be configured on the backend.

At 814, the system 100 can compute different types of margin data, and generate output for transmission, storage, or display at an interface, for example, a user interface.

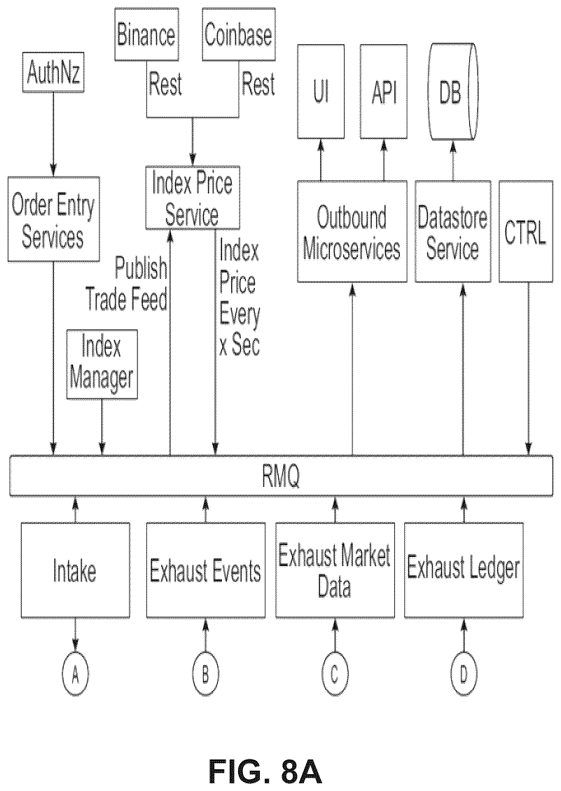

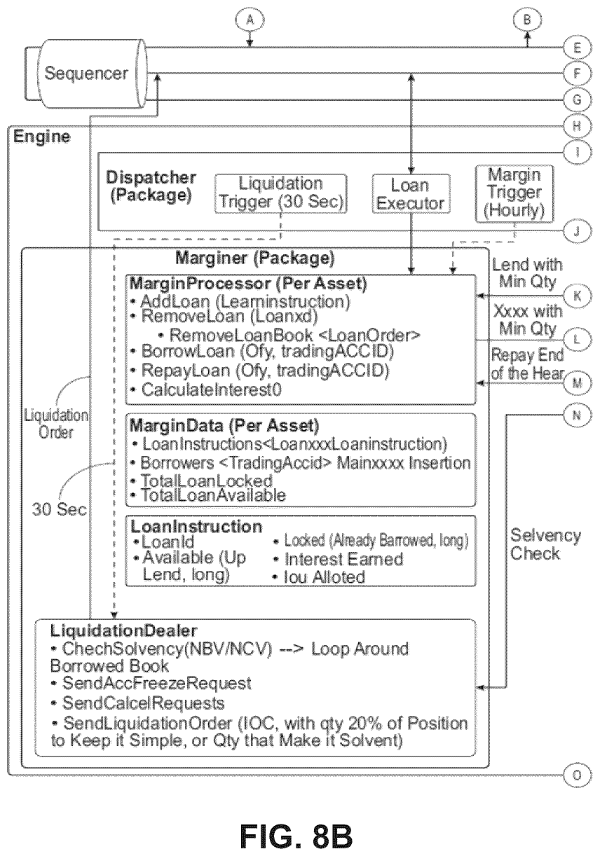

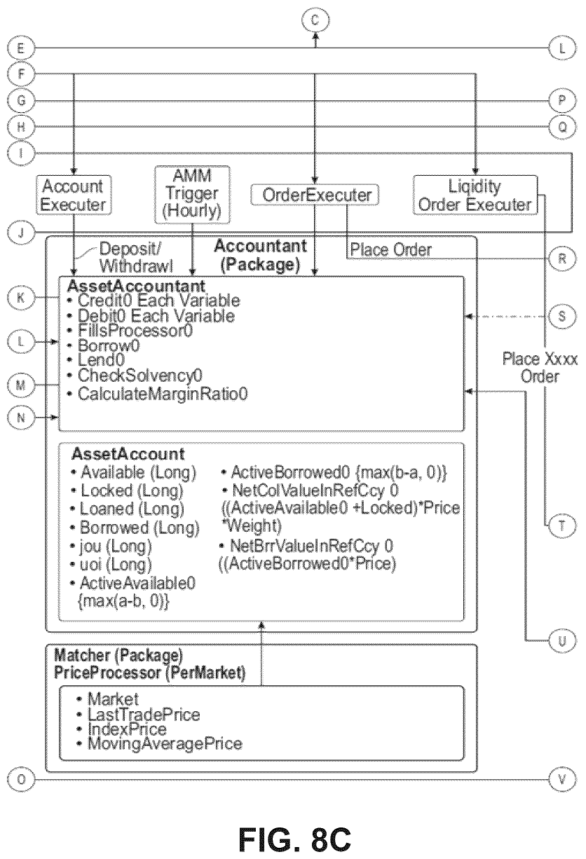

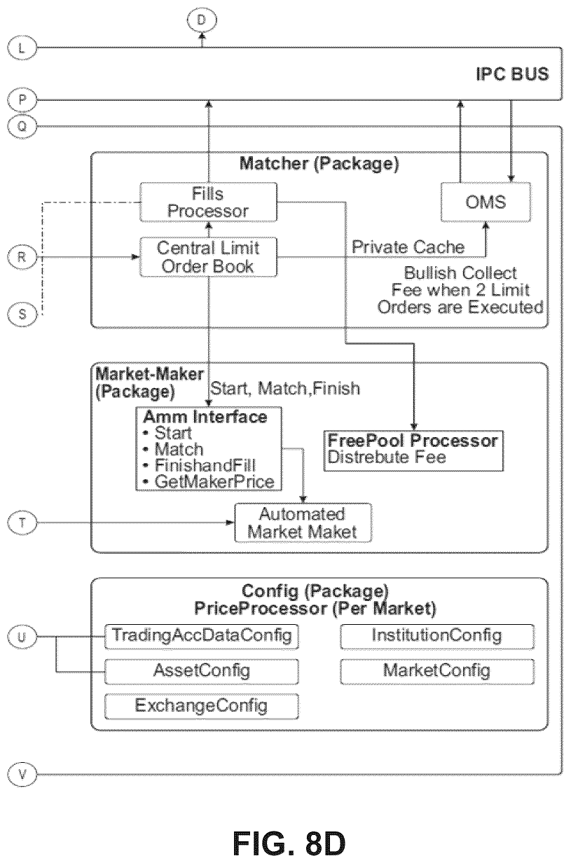

FIGS. 8A, 8B, 8C, 8D show a schematic diagram of a computer system for on-demand margin borrowing and lending.

FIG. 8A depicts the initial inputs and the outputs of a computer system for on-demand margin borrowing and lending which feed into the sequencer. The initial inputs include the AuthNz into the Order Entry services, Binance, and Coinbase into the IndexPriceServices, the IndexManager, and the CTRL into the range minimum query (RMQ). While Biance and Coinbase are depicted in the example, the system 100 could be configured for inputs from other cryptocurrency exchanges. The intake is inputted into the sequencer which is then inputted into the Engine (see FIGS. 8B, 8C, 8D). The outputs to the RMQ include Exhaust events, Exhaust Market Data, and Exhaust Ledger. From the RMQ the Outbound Microservices output to UI and API, and the Datastore Service outputs to database (DB).

The IndexPriceService can get price feeds either via REST or WS from Coinbase and Binace, and via RMQ. The service will choose a price on the basis of the index price. Periodically (e.g., every X seconds) the price will get fed to the margin engine. The price from all margin value calculations will be used. The price feed will also have a timestamp. If the timestamp is too old, the engine will choose to consider exchange fee prices for calculation.

FIGS. 8B, 8C, 8D depicts the Sequencer and the Engine. The Engine can have, for example, the dispatcher package, the market-maker package, the marginer package, the matcher package and PriceProcessor, the config package and PriceProcessor, and the accountant package. These are example components of the Engine.

The Margin Engine is a separate process that connects to the IPC bus. The Margin Engine consumes AssetAccount updates and maintains cache as a direct copy. Every 30 seconds the margin engine receives a trigger from the dispatcher package. Liquidator consumes the trigger and checks loan to value (LTV) for all the borrowed tradingAccounts. Maintenance Leverage is triggered if LTV≥margin call loan to value (MLTV) and LTV<liquidation loan to value (LLTV). If Maintenance Leverage is triggered, the system sends a Margin Call and changes the account status to Maintenance Leverage and reject all the requests (e.g., a transfer request or a new order request) that increases LTV. At this point, the Margin Engine will send the cancel request. To accomplish this, the Margin Engine has to maintain an order management system (OMS), terminate all open loans for this Margin Engine, and maintain the open loan list. Partial Liquidation is triggered if LTV≥MLTV and LTV<(1+LLTV)/2. If Partial Liquidation is triggered the system changes account status, and sends Partial Liquidation orders as per control commands from the processor 110. Partial Liquidation is triggered if LTV≥(1+LLTV)/2. If Full Liquidation is triggered the system changes the account status and sends Full Liquidation orders as per control commands from the processor 110.

The dispatcher package can include different components such as: the 30 second Liquidation Trigger, LoanExecutor, hourly Margin Trigger, Account Executer, OrderExecuter, hourly AMM Trigger, and the Liquidity Order Executor.

The matcher package can include different components such as: Fills Processor, Central Limit Order Book, and OMS.

The market-maker package receives inputs from the dispatcher and the matcher package, and consists of the AMM Interface, FreePool Processor, and Automated Market Maker.

The marginer package can include different components such as: the MarginProcessor, the MarginData, LoanInstructions, and LiquidationDealer. The marginer package receives inputs from the dispatcher package and the accountant package, and outputs to the sequencer and the accountant package.

The marginer package's Margin Processor can include different components such as: addLoan, removeLoan, borrowLoan, repayLoan, and calculateInterest. The loan removal function will remove the available loan from loanBook. When the loan removal function executes, LoanId gets added in loansToBeRemoved<loanIds>, and is actively flagged. Upon the hourly trigger, funds available from the active loan can get moved to loan that is marked to be removed, which will increase runningRate (the highest interest rate of the loans taken by the borrower in one sweep). Once all loanQty has been collected against the loanID, that loan will be closed and removed from loans ToBeRemoved and loanOrders, and at the same time (or at a suitably short time after), the asset gets credited to available in AssetAccount. If there is no new loan to fill, loanToBeRemoved will need to trigger lender last resort, and in the subsequent hour (or after a specified number of days) the least collateralized position (LCP) will be liquidated. The LCP is the riskiest position, in other words, the position with the highest leverage.

The marginer package's MarginData can include different components such as: loanInstructions, borrowers, totalLoanLocked, and totalLoanAvailable.

The marginer package's LoanInstruction includes the following example functions: loanId, available, locked, interestEarned, and iouAllotted.

The marginer package's LiquidationDealer includes the following example functions: checkSolvency (net borrowed value (NBV)/net collateral value (NCV)), sendAccFreezeRequest, sendCalcelRequests, and sendLiquidationOrder (immediate or cancel order (IOC), with quantity 20% of position to keep it simple, or quantity that makes it solvent).

The matcher package and PriceProcessor includes the following example functions: market, lastTradePrice, indexPrice, and movingAveragePrice. The matcher package and PriceProcessor outputs to the accountant package.

The config package and PriceProcessor can include different components such as: TradingAccDataConfig, InstitutionConfig, AssetConfic, MarketConfig, and ExchangeConfig. The config package and PriceProcessor outputs to the accountant package.

The config package and PriceProcessor's ExchangerConfig can include different components such as: Default, Full Liquidation, Partial Liquidation, Maintenance Leverage, maxOpenLoans, and maxOpenOrder. Default is where manual effort is required to unlock the account and access the assets. At Default, the customer looses complete control of its account and it is assumed defaulted and locked by the system 100 from further actions. At this point, the LTV≥(1−1/Default Leverage) (97% for a leverage of 30×). Full Liquidation is the point at which the liquidation engine uses a very aggressive price at +/−3% with the goal to generate 100% debt as USD collateral to repay loans. Partial Liquidation is the point at which the liquidation engine takes control and starts partially liquidating the customer's positions at +/−1%. Maintenance Leverage is the point at which a margin trigger warning message will be sent to customers once per hour. The system 100 periodically checks all accounts to calculate the amount borrowed versus collateral, determine the leverage, and assess the state of each account (e.g., healthy state, margin warning state, partial liquidation state, full liquidation state). The warning message can provide various information to a customer, such as, an indication of the state of the customer's account and/or recommendations to improve the health of their account (e.g., by adding more assets, by reducing debt, by reducing positions). The frequency of checks is configurable in the backend of the system 100.

The accountant package consists of the AssetAccountant and AssetAccount. The AssetAccountant is responsible for all accounting related functionalities. AssetAccountant holds functions like: credit( ) for all accounting fields, debit( ) for all accounting fields, onFill( ) for settlement after execution, borrow( ) lend( ) checkSolvency( ) and calculateMarginRatio( ) These functions are responsible for doing accounting on AssetAccount accounting fields consisting of: available (actual holding−total available quantity), locked (actual holding−total locked quantity on open orders), loaned (place holder, not an actual holding), borrowed (actual holding−total borrowed quantity), iou (incase the borrower goes into default and cannot pay the asset lender, the engine will assign equal amounts of IOUs to lender, which then exchange overtime to pay the lender), uoi (e.g., in the event that borrower goes into default (i.e., collateral<debt), the exchange assignes iouBorrowed with the exact quantity by which borrower defaulted, then over time the exchange can automatically update the quantity as the borrower pays back the equivalent defaulted quantity), activeAvailable( ) (max(available−borrowed, 0), activeBorrowed( ) (max(borrowed−available, 0), netCollateralValueInRefCcy( ) {(activeAvailable( )+locked)*price}, netBorrowedValueInRefCcy( ) {(activeBorrowed( )*price}. The accountant package receives inputs from the config package and PriceProcessor, the matcher package, the dispatcher package, the marginer package, and the matcher package and PriceProcessor. The AssetAccountant receives inputs and outputs to the MarginProcessor when a lender is lending, a borrower is borrowing, or a repayment is being made. The AssetAccountant also receives inputs and outputs to the LiquidationDealer as a solvency check.

The AssetAccountant's lend( ) function can use the common assetAccount to lend out assets. To lend, lender will create a loanOrder specific to an asset, that will debit asset from AssetAccount available and place an open order in loanOrders (the same amount gets recorded in loaned and filed in AssetAccount). A loan order will get consolidated into a loanBook, which is specific to an asset.

The AssetAccountant's borrow( ) function will use the common assetAccount to borrow assets. On borrowing, the available and borrowed in assetAccount increase with the newly borrowed amount. The active borrowers will get tracked in Borrowers<tradingAccountId>. The system only allows borrowing on tradingAccount where margin is available, this will be validated at the AuthNz level, and an order will get stamped with isMargin. Borrowers can only borrow assets if the account is not already loaning the same asset, otherwise the system will reject the order. By default, the assetAccount has auto-borrowing, that means on Margin short asset orders, if there is insufficient asset, the assetAccount makes a call to borrow extra quantity only if the order quantity less the available quantity is less than or equal to the maximum borrow quantity, otherwise the system rejects the order. Maximum borrowing quantity (maxBorrowQty) is the maximum quantity that can be borrowed depending on the allowed leverage and LTV across all assets. LTV is calculated as SUM (netBorrowedValueInRefCcy/SUM (netcollateralValueInrefCcy*collateralWeight)). The variable collateralWeight is the static number allocated to each asset, and can be changed in assetConfig via CTRL. LTV calculations do not get triggered on every order, only on a need to borrow basis.

The Autorepayment function occurs every hour to repay min (available, borrowed) from any assetAccount if the amount borrowed is greater than 0. The system 100 will repay the loan with the highest rate first, this way the borrower can keep using the borrowed quantity for which they have already paid the interest upfront for an hour. This function of system 100 helps reduce need to borrow calls, reducing computing resource consumption and latency.

In some example embodiments, there may be a Matcher package that includes the following example functions PerpetualProcessor (per market), PerpetualData, PerpetualPosition, LiquidationDealer, MarginProcessor (per asset), and LoanInstruction.

In some example embodiments, there may be a PerpetualProcessor that includes the following example functions: handleMarkToMarket, handleFunding, handleSettlement, and onFill.

In some example embodiments, the PerpetualPosition can include the following example functions: tradingAccountId, marketId, quantity, notational, fundingPnl, mtmPnl, settlementAssetId, reportedMtMPnl, and reportedFundingPnl.

In some example embodiments, there may be a LiquidationDealer that includes the following example functions: checkSolvency (NBV/NCV), sendAccFreezeRequest, sendCalcelRequests, and sendLiquidationOrder (IOC, with qty 20% of position to keep it simple, or qty that makes it solvent).

In some example embodiments, there may be a LoanInstruction that includes the following example functions: loanId, available, locked, interestEarned, and iouAllotted.

In some example embodiments, there may be a PriceProcessor that includes the following example functions: market, lastTradePrice, indexPrice, and movingAveragePrice.

The MarginData can have the following functions: loanInstructions, borrowers, totalLoanLocked, and totalLoanAvailable.

In some example embodiments, the MarginProcessor can have one or more of the following functions: addLoan, removeLoan, borrowLoan, repayLoan, and calculateInterest. The loan removal function will remove the available loan from loanBook. loanId gets added in loansToBeRemoved<loanIds>, and is actively flagged. Upon the hourly trigger, funds available from the active loan will get moved to loan that is marked to be removed, which will increase runningRate (the highest interest rate of the loans taken by the borrower in one sweep). Once all loanQty has been collected against the loanID, that loan will be closed and removed from loans ToBeRemoved and loanOrders, and at the same time (or at a suitably short time after), the asset gets credited to available in assetAccount. If there is no new loan to fill, loanToBeRemoved will need to trigger lender last resort, and in the subsequent hour (or after a specified number of days) LCP will be liquidated.

Under interest calculation function(s), interest can get charged upfront on pickup of a loan at a new runningRate for that hour. Upon the hourly trigger, a Borrower's book will get swept and all the loanedQty will get charged at the runningRate. The Borrower pays the runningRate plus exchange fees, for example. Periodic (e.g., hourly) triggers by the system 100 cause the following events to occur in chronological order: (a) Auto-repayment, (b) Loan Removal, and then (c) Interest Charged.

When an order is placed, the system 100 proactively checks the LTV ratio (netBorrowedValue=SUM (activeBorrowed( )*lastTradePrice), and maintains and open order list for a client. For a Limit order: execPrice→limitPrice. For a Market order: execPrice→cost/quantity. At each level: avaliableCollateralValue=activeAvailable( )*priceInUsd, netCollateralValue=SUM (minLockedColValue+availableColValue), LTV=netBorrowedValue/netCollateralValue. A depiction of an open order list for a client is shown below:

The tables below show an accounting example. In this example, Alice, the Lender, opens three loans with 10 ETH at 1 bps, 20 ETH at 2 bps and 70 ETH at 2 bps. Bob, the Borrower, placed ETHUSD SELL 9 passive limit order.

| Asset | [symbol] | [symbol] ( [symbol] ) | [symbol] | borrowed | price | [symbol] weight | [symbol] |
|---|---|---|---|---|---|---|---|
| [symbol] | 0 | 0 | 1 [symbol] 0 | 0 | [symbol] 000 | 0 | [symbol] |

[symbol]

indicates data missing or illegible when filed

| [symbol] | [symbol] | [symbol] | [symbol] | [symbol] | [symbol] | [symbol] | [symbol] |
|---|---|---|---|---|---|---|---|
| [symbol] | [symbol] | 1 | 10 | 0 | 1 | 0 | [symbol] |
| | [symbol] | [symbol] | 20 | 0 | | 0 | [symbol] |
| | [symbol] | 2 | 70 | 0 | | 0 | [symbol] |

[symbol]

indicates data missing or illegible when filed

| [symbol] | [symbol] | [symbol] | [symbol] | [symbol] | [symbol] | [symbol] | [symbol] |
|---|---|---|---|---|---|---|---|
| [symbol] | 0 | [symbol] | 0 | 0 | [symbol] | [symbol] | 0 |
| [symbol] | 0 | 0 | 0 | 0 | [symbol] | [symbol] | |
| [symbol] | 100 | 0 | 0 | 0 | [symbol] | 0 | |

[symbol]

indicates data missing or illegible when filed

Since there is no available ETH and the margin ratio is 0, the assetAccountant will request for borrow. This will result in upfrontCharged to Bob at 1 bps and in the following changes (assuming 3× leverage is allowed):

| [symbol] | [symbol] | [symbol] | [symbol] | [symbol] | [symbol] | [symbol] | [symbol] |
|---|---|---|---|---|---|---|---|
| [symbol] | 1111 | 1 | 1 | [symbol] | 1 | [symbol] | [symbol] |
| | 1112 | [symbol] | 20 | 0 | | | [symbol] |
| | [symbol] | [symbol] | [symbol] | 0 | | | [symbol] |

[symbol]

indicates data missing or illegible when filed

| [symbol] | [symbol] | [symbol] | [symbol] | [symbol] | price | [symbol] | LTV |
|---|---|---|---|---|---|---|---|
| [symbol] | 0 | [symbol] | 0 | 0 | [symbol] | [symbol] | [symbol] |
| [symbol] | 0 | [symbol] | 0 | [symbol] | [symbol] 000 | 0 | |
| [symbol] | 100 | 0 | 0 | 0 | [symbol] | 0 | |

[symbol]

indicates data missing or illegible when filed

The following table depicts what would happen if Bob sends another SELL 4 ETH order. This will get upfrontCharged to Bob at 2 bps, and result in the following changes:

| [symbol] | [symbol] | [symbol] | [symbol] | [symbol] | [symbol] | [symbol] | [symbol] |
|---|---|---|---|---|---|---|---|
| [symbol] | [symbol] | 1 | 0 | [symbol] | [symbol] | [symbol] | [symbol] |
| | [symbol] | [symbol] | [symbol] | [symbol] | | [symbol] | [symbol] |
| | [symbol] | [symbol] | 70 | 0 | | | [symbol] |

| [symbol] | [symbol] | [symbol] | loaned | borrowed | price | [symbol] | [symbol] |
|---|---|---|---|---|---|---|---|
| [symbol] | 0 | [symbol] | 0 | 0 | [symbol] | [symbol] | [symbol] |
| [symbol] | [symbol] | [symbol] | 0 | [symbol] | [symbol] 000 | 0 | |
| [symbol] | 100 | 0 | 0 | 0 | [symbol] 0 | 0 | |

[symbol]

indicates data missing or illegible when filed

Below, depicts what would occur is Bob cancels SELL 4 ETH order:

| [symbol] | available [symbol] ( [symbol] ) | [symbol] | [symbol] | borrowed | price | weight | [symbol] |
|---|---|---|---|---|---|---|---|
| [symbol] | 0 | [symbol] | 0 | 0 | [symbol] | [symbol] | [symbol] |
| [symbol] | [symbol] | [symbol] | 0 | [symbol] | [symbol] 000 | 0 | |
| [symbol] | 10 [symbol] | 0 | 0 | 0 | [symbol] 0 | 0 | |

[symbol]

indicates data missing or illegible when filed

Below, depicts what would occur if Alice sends a removeLoan request for loanId 1111. This request will get tracked in loansToBeRemoved, and isActive flag. Upon the hourly trigger, Auto-Repay would repay 4 ETH back to the loanBook (the loan with the higher rate getting filled first by the system 100), Bob's available becomes 0 and borrowed becomes 9.0000708, and runningRate becomes 1 bps.

| [symbol] | [symbol] | [symbol] | [symbol] | [symbol] | [symbol] | [symbol] | [symbol] |
|---|---|---|---|---|---|---|---|
| [symbol] | 1111 | 1 | [symbol] | [symbol] | 1 | [symbol] | [symbol] |
| | 1112 | 2 | [symbol] | 0 | | [symbol] | [symbol] |
| | 111 [symbol] | [symbol] | [symbol] | 0 | | | [symbol] |

[symbol]

indicates data missing or illegible when filed

| [symbol] | available | [symbol] | [symbol] | borrowed | price | weight | [symbol] |
|---|---|---|---|---|---|---|---|
| [symbol] | 0 | [symbol] | 0 | 0 | [symbol] | [symbol] | [symbol] |
| [symbol] | 0 | [symbol] | 0 | [symbol] | [symbol] 000 | 0 | |
| [symbol] | [symbol] | 0 | 0 | 0 | 20 | 0 | |

[symbol]

indicates data missing or illegible when filed

Since for the loan with loanID 1111, the locked amount is 9.0000708, the same amount will get debited from next active loan (i.e., 1112) and credited to the loan with loanID 1111. Once there is no asset locked for the loan with loanID 1111, it will get removed from the loanBook. The loan amount (with interest) gets credited to the spot account of Alice (the Lender). The new runningRate becomes 2 bps, as shown below:

| [symbol] | [symbol] | [symbol] | loaned | borrowed | price | weight | [symbol] |
|---|---|---|---|---|---|---|---|
| [symbol] | [symbol] | 0 | [symbol] | 0 | [symbol] 000 | 0 | [symbol] |

[symbol]

indicates data missing or illegible when filed

Interest will be charged on the new runningRate for the following hour, as shown below:

| [symbol] | [symbol] | [symbol] | [symbol] | [symbol] | [symbol] | [symbol] | [symbol] |
|---|---|---|---|---|---|---|---|
| [symbol] | 111 [symbol] | [symbol] | [symbol] | [symbol] | [symbol] | [symbol] | [symbol] |
| | 111 [symbol] | [symbol] | 70 | 0 | | | [symbol] |

[symbol]

indicates data missing or illegible when filed

| [symbol] | available | [symbol] | [symbol] | borrowed | price | weight | [symbol] |
|---|---|---|---|---|---|---|---|
| [symbol] | 0 | [symbol] | 0 | 0 | [symbol] 000 | [symbol] | [symbol] |
| [symbol] | [symbol] | [symbol] | 0 | [symbol] | [symbol] 000 | 0 | |
| [symbol] | 100 | 0 | 0 | 0 | [symbol] | 0 | |

[symbol]

indicates data missing or illegible when filed

It is important to note that each jurisdiction will likely have unique requirements for offering margin to Institutional and/or Accredited investors. In terms of legal considerations, each lender will receive the same annual percentage rate (APR) as other lenders (which will be greater than or equal to the lending rate specified upon agreeing to loan the assets). APRs are converted to specific asset amounts by converting the yearly rate to an hourly amount of assets. The system 100 calculates this by dividing the loan amount by 365*24=8766. Each borrower will pay a unique APR, based on the common lender rate and a formula involving that customer's taker fee. Borrowers pay [APR*X*(1+Global.InterestTakerMultiplier*Taker Fee)/(100*365*24)], assuming that some amount X of capacity has been agreed to be borrowed from one or more lenders and the most expensive of those lenders requires a minimum interest rate APR. The Taker Fee is the client's default taker (if configured), or else it is the taker fee for trading asset vs USD if the asset itself is not USD, otherwise the taker fee is for trading BTC/USD. The Borrowers' payment must be split between the lenders and the exchange. The lenders collectively receive [APR*X/(100*365*24)], with each lender receiving a pro-rated amount. The remainder, the amount paid by the borrower minus the amount split between lenders, is income for the exchange.

In some embodiments, there may be subaccounts with zero or more balances in each tradeable asset. Each onboarded customer (legal onboarded entity and beneficial owner) has one or more subaccounts. Each subaccount has zero or more balances in each tradable asset. Each balance for each asset can be split into multiple categories (i.e., Available, OnMarket, Loaned, Borrowed), each of which is either a Holding (aka Asset) or a Liability. The category “Available” indicates the amount of a particular asset available immediately without paying additional borrowing fees. The category “OnMarket” indicates the amount on the order book which might be converted into some other asset due to an exogenous event (e.g., locked in limit orders and AMM Instructions). The category “Loaned” indicates the amount of the respective asset allocated to Loans that are Active or Terminating (this does not include any amount of a Terminating loan which has already been returned to the user's control). By convention, Liabilities are shown as negative. Changes to balances are automatically made by the system 100 and connected to some event (e.g., trading activities, custody activities, transferring assets within accounts). For example, the system 100 can implement automated repayment of debts or loans with the idle assets of a trader and a lender can automatically be replayed. For example, by default, the assetAccount has auto-borrowing, that means on margin short asset orders, if there is insufficient asset, the assetAccount makes a call to borrow extra quantity only if the order quantity less the available quantity is less than or equal to the maximum borrow quantity, otherwise the system rejects the order. Additionally, the Autorepayment function occurs every hour to repay min (available, borrowed) from any assetAccount if the amount borrowed is greater than 0. The system will repay the loan with the highest rate first, this way the borrower can keep using the borrowed quantity, for which they have already paid the interest upfront, for an hour. This automatic function helps reduce the number of borrow calls that need to be made by the system 100.

The table below is an example of a subaccount with 2 tradable assets with a non-zero balance.

| Holdings (aka Assets) | | | | Liabilities |
|---|---|---|---|---|
| Asset | Available | OnMarket | Loaned | Borrowed |
| BTC | 5 | 2 | 1 | 0 |
| ETH | 0 | 0 | 0 | −10 |

Movement between categories is automatically managed by the system 100. For example, a new limit order automatically moves some balance from Available Holdings to OnMarket Holdings. Additionally, when new assets are added (e.g., deposited or transferred from another subaccount, or unlocked from some other purpose), Available Holdings are automatically increased. Further, when assets are required, the following order of operations always occurs: (a) if the LTV>current or indexed LTV the request is rejected, but if loan to value ratio (debt divided by collateral) (LTV) is ≤current or initial LTV step (b) is preformed; (b) Available Holdings is reduced as much as possible to meet the asset requirement; and (c) if necessary, Borrowed Liabilities is increased. It is important to note that Available Holdings are offset against Borrowed Liabilities automatically by the system 100 on a regular basis, but both values may be non-zero at the same time (although the front end does not show these details to the customer in the user interface). The table below shows an example of balances moving between categories in a subaccount. In this example, at TO (when account is created) there are no balances. At T1, deposits into BTC are made. At T2, there is a limit order to sell BTC but no trade has been executed yet, meaning there are 9 BTC available and 1 BTC on the market. At T3, there is an offer to loan 6 BTC for ≥3% APR. At T4, AMM instructions are submitted for 7 BTC vs some USD which requires borrowing 4 BTC.

| | | | | |
|---|---|---|---|---|
| Assett | Available | OnMarket | Loaned | Borrowed |

T0: Account created

| | | | | |
|---|---|---|---|---|
| BTC | 0 | 0 | 0 | 0 |

T1: Deposit 10 BTC

| | | | | |
|---|---|---|---|---|
| BTC | 10 | 0 | 0 | 0 |

T2: Limit order to sell 1 BTC for some USD (not shown here)

| | | | | |
|---|---|---|---|---|
| BTC | 9 | 1 | 0 | 0 |

T3: Offer to loan 6 BTC for ≥3% APR

| | | | | |
|---|---|---|---|---|
| BTC | 3 | 1 | 6 | 0 |

T4: Submit AMM Instruction for 7 BTC vs some USD (not shown here).
Requires us to borrow 4 BTC.

| | | | | |
|---|---|---|---|---|
| BTC | 0 | 8 | 6 | (4) |

What is displayed as the Available Holding can be less than what the API returns as the e available balance. What is displayed as the Available balance is max(0,Holdings→Available−Liabilities→Borrowed). What is displayed as the Borrowed balance is max(0,Liabilities→Borrowed−Holdings→Available).

When Lenders create new loan offers using the frontend interface, the loan instruction is submitted to the backend of system 100 for approval. Users can create a loan directly from the Portfolio-Lending page of the user interface after electronically indicating that they agree to terms and conditions of use. Loan instructions are submitted either as the value of the loan in a specific currency (e.g., USD), or through selectable indica (i.e., sliding the slider to lock in the loan amount). For example, the position of the dot on the slider can reflect the loan amount relative to the maximum loan amount allowed (in the same way as on the order entry slider). The Lender only needs to enter the new loan amount for a new loan request to be created. In order for the request to gain approval from the backend, the amount of the asset set by the Lender must be ≥$100 in value and must be ≤Available Holdings. Holdings locked (under Loaned) in a particular loan offer are not available for any other purposes while locked. When the loan instruction is submitted and then approved by the backend of system 100, the full offered amount will be moved from the Lender's Available Holdings into their Loaned Holdings balance to prevent the full offered amount being hypothecated for some other purpose.

When a Lender is creating a loan offer using system 100, the lender interface will display the following data: Current Market APR, Available Amount, and the loan value slider control (i.e., selectable indica) starting and ending points. The Current Market APR represents the APR in the current hour. The Available Amount represents the quantity of the idle balance (i.e., the quantity of an asset available to loan) and its formula is IdleBalanceₐₛₛₑₜ. The slider control's starting point represents the minimum loan amount and its formula is Min Loan USD Value, global config set in CTRL, and the slider control's ending point represents the maximum loan amount and its formula is IdleBalanceₐₛₛₑₜ.

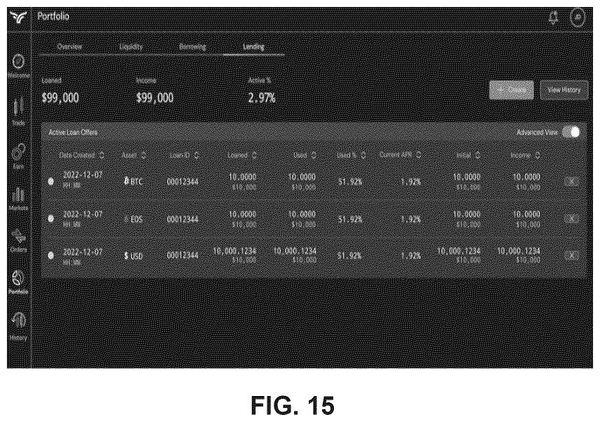

Customers may request to terminate their existing loan offers using an interface (e.g., using a similar UX as AMM Instructions). FIGS. 11 and 15 show an example lender interface for a lender terminating an existing loan. In the example in FIG. 11, there are three Active Loan Offers (existing loans), and the lender can choose to terminate a particular loan by clicking the red ‘x’ corresponding to the particular loan. FIG. 15 shows that the lender must confirm before system 100 will terminate the loan. Lenders may request to terminate any given loan offer, at any time, however, successful termination depends on whether the loan is being used or not. If no part of the loan is being utilized, then the entire loan amount (which automatically includes accrued interest calculate by the system 100) is returned to the lender's Available Holdings immediately after the loan offer is terminated. A lender can terminate a loan by clicking the ‘x’ of an active loan, at which point the lender is prompted in the user interface to confirm the loan termination by the backend of system 100.

The table below shows the lender interface for customers viewing existing loans. The table has two views, Default and Advanced, and users can switch between the two views via a toggle accessible in the user interface.

Margin is automatically disabled by the system 100 for new subaccounts, and margin must be explicitly enabled by the customer using the user interface. Specifically, in some embodiments, only a customer user in the Appointed Representative (e.g., administrator) category can enable margin or change margin settings. Appointed Representatives can move a slider (or similar UX) to set, for example, “No Margin”, 1.5×, 2×, 2.5×, 3×, or “Maximal Initial Leverage” (see examples in FIGS. 5, 6, and 7).

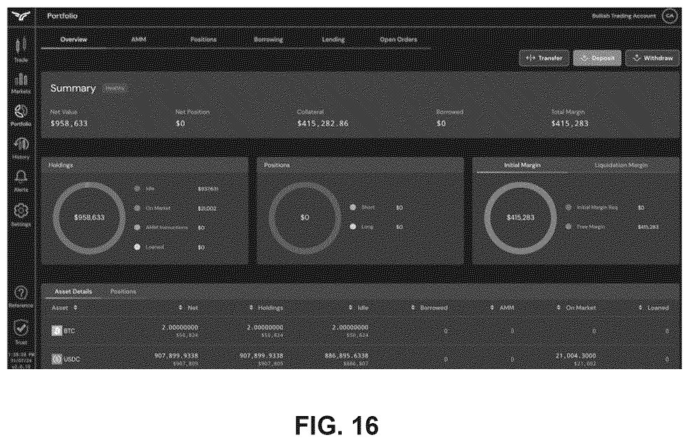

A customer can view their current leverage and margin ratio values on a portfolio screen found in the user interface of the system 100. See, for example, FIG. 16 and FIG. 5, which are example interfaces displaying current leverage and margin ratio values. On the portfolio screen, the system 100 can display a table showing all the assets with non-zero balances held by the customer, with each row showing: the asset ticker, total (all holdings summed), total (USD) based on current price, Available (Holdings), Available Collateral (USD) based on (Available+Collateral) at current price and collateral weighting for the asset, debt (Borrowed Liabilities), debt (USD) based on current price, and liquidation price for that asset. The table should be updated at least once every 10 seconds by the system 100, with the user interface refreshed to display the updated values to the customer. In addition, the customer can view an explainer indicating how leverage and margin are computed from the Collateral and Borrowed values. The system 100 displays explainers via the user interface, although the system may also send emails, or provide alerts in other ways.

FIG. 10 shows an example user interface with visual elements corresponding to a “health indicator” which is visible for the customer. In this example, the current health indicator or health category of the account is “healthy”. The user interface can also indicate a total margin requirement value, IM %, and LM %, for example. The health indicator can be one of six possible categories for each subaccount: healthy (no borrowing or leverage of 1.23×), monitor (leverage of 3.45×), caution (leverage of 5.67×), danger (leverage of 6.78×), critical (leverage of 23.45×), or suspended (over 23.45×). The leverage values for the categories can be set system-wide but can be configured on the backend of the system 100. For example, system 100 can use machine learning to adjust the heath indicator categories. The backend of the system 100 calculates which category should be displayed, and what user actions and system actions are available based on the customer's leverage range for each subaccount, as seen in the table below. For example, the system displays “Healthy” under two conditions: (a) with no borrowing if the leverage range is from 0≤1 (inclusive) and (b) with borrowing if the leverage range is from <1 (exclusive) to maximum initial leverage (exclusive). If the subaccount is labelled “Healthy”, the backend allows users to borrow, trade to increase leverage, trade to reduce leverage, cancel orders, deposit, and/or withdraw. On the other hand, the system displays “Caution” if the leverage range is from MarginCall Leverage (inclusive) to PartialLiquidation Leverage (exclusive). If the subaccount is labelled Caution, the back end only allows users to trade to reduce leverage, cancel orders, and deposit. It does not allow users to borrow, trade to increase leverage, or withdraw. Further, the system delivers a margin warning in the user interface, and sends a margin call email notification.

| [symbol] | | [symbol] | | [symbol] | | | | | | | | |
|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | |
| [symbol] | [symbol] | [symbol] | [symbol] | Yes | Yes | Yes | Yes | [symbol] | Yes | [symbol] | [symbol] | [symbol] |
| [symbol] | [symbol] | [symbol] | [symbol] | Yes | Yes | Yes | Yes | [symbol] | [symbol] | [symbol] | [symbol] | [symbol] |
| [symbol] | [symbol] | [symbol] | [symbol] | No | No | Yes | Yes | [symbol] | No | [symbol] | [symbol] | No |
| [symbol] | [symbol] | [symbol] | [symbol] | No | No | Yes | Yes | [symbol] | No | [symbol] | [symbol] | No |
| [symbol] | [symbol] | [symbol] | [symbol] | No | No | No | No | [symbol] | No | [symbol] | [symbol] | No |
| [symbol] | [symbol] | [symbol] | [symbol] | No | No | No | No | [symbol] | No | [symbol] | [symbol] | No |
| [symbol] | [symbol] | [symbol] | [symbol] | No | No | No | No | [symbol] | No | [symbol] | [symbol] | No |
| [symbol] | [symbol] | [symbol] | [symbol] | No | No | No | No | [symbol] | No | [symbol] | [symbol] | No |

[symbol]

[symbol]

indicates data missing or illegible when filed

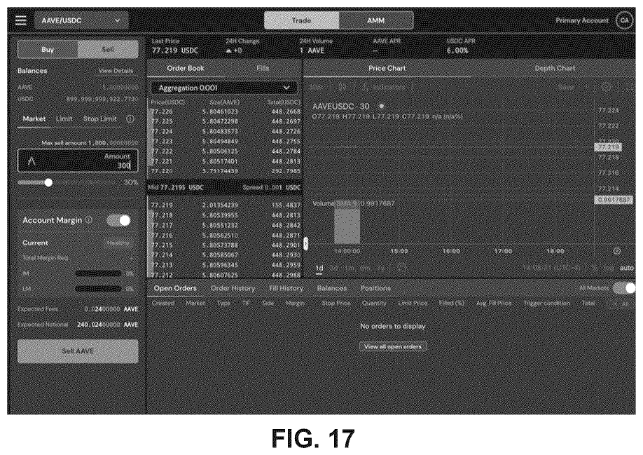

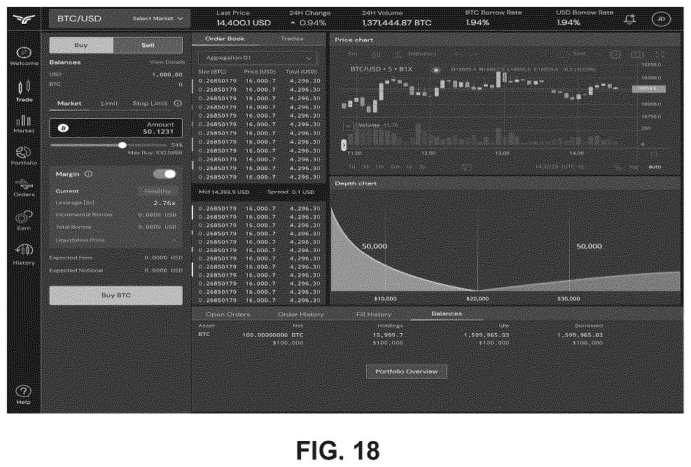

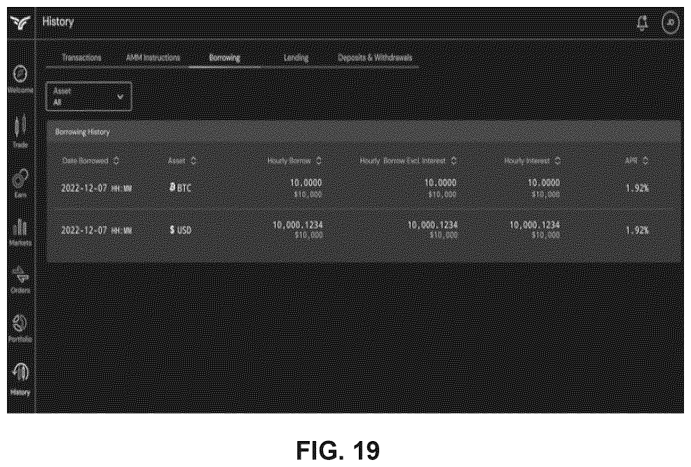

The system 100 provides information to a customer on the trade screen so that a customer can understand their leverage before trading on the trade screen. Even if the customer is not currently enabled for margin, a new section on the trade screen will become visible. This new section will show, at least, cost of incremental borrow in quote (APR), cost of incremental borrow in base (APR), and a notice saying that margin is not enabled and a link to the margin settings tab so the customer can enable margin from the margin setting tab, if desired. If margin is enabled for the subaccount, the trade screen will show, at least, the customer's chosen max leverage (1/Margin Ratio (MR)). FIG. 17 shows an example trade screen. FIG. 18 shows an example of the borrower interface displaying borrowing history.

When the user (i.e., the Appointed Representative) has enabled margin, a “margin on/off” switch will be added to the order entry panel in the user interface. If the margin is switched off, the panel behaves as it normally would. If the margin is switched on the panel computes the maximum amount borrowable given the customer's chosen maximum leverage setting, and adds that to the customer's residual balance. “Impact of planned action” will either be displayed in this panel, or in the confirmation dialogue panel. “Impact of planned action” will contain information such as: current and future margin ratio (MR), current and future leverage (1/MR), current and future liquidation price, and a link directing the customer to the portfolio leverage explainer tab.

The following is an example of how margins are calculated using examples of assets of $20,000 value, collateral of $15,000 value, and debts of $8,000 value: LTV is calculated as a ratio of debt to collateral value (in this example, $8,000/$15,000=53%). MR is calculated as the ratio of free collateral (collateral minus debt) to collateral (in this example, ($15,000−$8,000)/$15,000=46%). Leverage is calculated as the inverse of MR (in this example, $15,000/($15,000−$8,000)=2.14×). Maximum Initial Leverage, is the maximum leverage a borrower can enter a new position at, in this example 3×. This is an example only. ILTV is calculated as the corresponding value to Max Leverage (in this example, 1−(⅓)=67%). Margin Call Loan to Value is calculated as the corresponding to Margin Call Leverage, in this case, Margin Call Leverage is 5× (in this example, 1−(⅕)=80%). LLTV is calculated as the corresponding to Liquidation Leverage, in this case, liquidation leverage is Partial Liquidation Leverage at 6× (1−(⅙)=83%).

In assessing collateral, the system 100 considers all assets within a given subaccount as potential collateral to borrow assets in that subaccount (“cross-margin within the account”). Assets in other subaccounts will not be considered for the purpose of calculating margin in a given subaccount (“isolated margin between accounts”). Collateral can be measured in using different processes and values. Collateral can be measured in using different currencies. For example, collateral can be measured in USD in some embodiments. Each asset will have a specific multiplier associated with it (“Collateral Rating” or “CR”) which determines how much of the nominal USD value can actually be used as collateral by system 100. For example, a weight of 90% means that $1,000 worth of that asset (at current prices) only accounts for $900 of collateral. The table below depicts the values used for Margin Day 1.

| Asset | Collateral Rating |
|---|---|
| AAVE | 25% |
| BTC | 95% |
| CRV | 50% |
| EOS | 50% |
| ETH | 95% |
| LINK | 50% |
| LTC | 50% |
| MANA | 0% |
| MATIC | 50% |
| SUSHI | 0% |
| UNI | 50% |
| USDC | 100% |
| USDT | 95% |
| XRP | 0% |
| DOGE | 0% |

The system 100 allows available assets and limit orders to be directly used as collateral. Since limit orders can be filed at any time, the worst-case scenario of their eventuality is used for calculation of collateral. That is, the minimum of [provided asset*convert to USD*provided asset collateral weight], and [target asset*limit price*convert to USD*target asset collateral weight].

The system 100 might not allow existing loans to be used as collateral, unless they are terminated successfully (i.e., no longer lent out), for example, via customer action and termination approval by the system 100.

Liquidation price is defined conservatively, as the price at which it is expected that a customer will lose control of the subaccount to the liquid engine. The liquidation price (in USD, for a given asset) determines what price that asset must move to, given the customer's assets and liabilities, in order for the LTV to be greater than or equal to the liquidation loan to value (LLTV). The system 100 sets a liquidation price in USD for each asset (except assets which do not change price relative to USD such as other fiat or stablecoins). The system 100 calculates liquidation price for day 1 margins by: assuming all fiat and stablecoins remain at their current prices, assuming all other assets are perfectly correlated, and then finding the price change versus USD which results in LTV equal to LLTV. In order to find the price change versus USD, Collateral and Debts are split into two collateral-rating weighted USD valued totals, cryptocurrency, and fiat/stablecoin (i.e., Cc (crypto collateral), Cs (crypto stable), Dc (crypto debts), Ds (stable debts), all denominated in USD at current prices). The liquidation price for any crypto asset can be expressed as a multiplier K of the current price. For example, K=80% means that the price needs to be multiplied by 0.8 (moved down by 20%) in order to liquidate [K=(LLTV*Cs−Ds)/(Dc−LLTV*Cc)].

Maintenance Leverage is the point at which a Margin Call occurs. When a Margin Call occurs on a customer's subaccount, a margin trigger warning message will be sent to the customer once per hour. Partial Liquidation is the point at which the Liquidation Engine takes control and starts partially liquidating the customer's positions at +/−1%. If leverage increases at 6×, the Liquidation Engine uses partial liquidation to bring leverage back under 6×. Full Liquidation is the point at which the Liquidation Engine uses a very aggressive price at +/−3% with the goal to generate 100% debt as USD collateral in order to repay loans. Default is the point at which the customer loses complete control of the account and it is assumed defaulted and locked from further actions. At the Default point, the LTV≥(1−1/Default Leverage) (97% for a leverage of 30×). At the Default stage, the account is frozen, open orders are canceled, no new orders, no withdrawals, and no outbound transfers are permitted by the system 100, and manual effort and full repayment of loans are required to unlock the account and access the assets. At different risk levels, the system 100 takes specific action and/or imposes specific restrictions on a customer. At regular intervals, the system 100 manages ‘states’ for accounts, which defines a set of actions that the system 100 will take. For example, if the system looks at the state of an account and determines the need to liquidate because of the risk level associated with borrowing BTC, the system will automatically send and order to buy BTC on the user's behalf using the user's USD, to make BTC available for the system 100 to automatically pay off the borrowed BTC. The table below shows the risk levels and the associated actions/restrictions.

The margin risk engine includes open order collateral to make liquidation less likely; however, if liquidation occurs, (assuming the Borrower has agreed to term of service), the exchange (i.e., the system 100) is able to take control of any of their trading accounts. The margin risk engine and the liquidation engine can be components of the same package. This provides the Lenders with a level of protection against Borrower liquidations. Further, if any one of the customer's accounts is in a state of liquidation, the exchange will disallow all withdrawals for that customer, even if there are sufficient balances available in the other accounts controlled by that customer. The customer must first resolve the liquidation state (e.g., by transferring asset balances from another account or by depositing new assets). There are several liquidation states but all are triggered when LTV≥margin call loan to value (MLTV).

When a loan default occurs on a subaccount, the subaccount has debts but no collateral (LTV of ∞). The exchange reserves the right to pursue the customer for additional payment, but such action by the exchange is not implemented systematically by the system 100. Other subaccounts belonging to the customer remain unaffected even if one subaccount is in default, and withdrawals from the main account will continue to be processed by the system 100. Configurations can be set at the main account level and also at the subaccount level. Each retail account or institutional account has a main account, which has specific properties that vary from a subaccount. There are also properties specific to a subaccount, which allows different subaccounts to be used for different trading strategies and different risk level, for example.

There are 3 margin statuses: (1) margin is ineligible for this organization, thus ineligible for all its subaccounts (for reasons such as jurisdiction); (2) margin is eligible for this organization but not enabled for this subaccount (i.e., max leverage=1× or no leverage); and (3) margin is eligible for this organization and enabled for this subaccount (max initial leverage>1×). There are four main actions for borrowers: (1) accept margin terms and conditions, this only needs to be accepted once for each organization; (2) edit maximum initial leverage (margin is enabled when maximum initial leverage is set higher than 1× and disabled when its set to 1×); (3) view margin (borrow) dashboard; and (4) allow margin for a specific trade (this action can be performed on a trading interface). The table below shows, for example, permutations of Trader and Authorized Representative users, and the three margin statuses and four actions.

| | [symbol] | [symbol] | | | [symbol] | | |
|---|---|---|---|---|---|---|---|
| [symbol] | c. View margin | a. Accept | b. Edit max | c. View [symbol] | b. Edit max | c. View margin | [symbol] Allow margin |
| Main actions | (borrow) dashboard | margin [symbol] | Initial leverage | (borrow) dashboard | Initial leverage | (borrow) dashboard | for [symbol] specific trade |
| [symbol] | Y | [symbol] | [symbol] | Y | [symbol] | Y | Y |
| [symbol] | Y | [symbol] | Y | Y | Y | Y | Y |

[symbol]

indicates data missing or illegible when filed

Under different margin statuses, users can perform different actions. Each user has different action permissions, thus seeing slightly different UIs on the Portfolio screen. The table below depicts variations of the trade screen for different margin statuses and users.

| | a. Margin is ineligible | | c. Margin is enabled for this |
|---|---|---|---|
| Status | for this organization | b. Margin is not enabled for this subaccount | subaccount |
| Trader | Margin toggle is hidden | Copy: | 1. Margin toggle is displayed |
| | | “Want to unlock more trading power? | 2. Turn on the toggle to trade |
| | | Contact your oranization's | on margin |
| | | Authorized Representative to enable margin’ | |
| | | Link: Learn More | |
| | | 1. Click ‘Learn More’ and will be taken to | |
| | | the Help Center | |
| Authorized | Margin toggle is hidden | Copy: | 1. Margin toggle is displayed |
| Representative | | “Enable margin on this account to unlock | |
| | | more trading power.” | |
| | | Button: Enable Margin | |
| | | 1. Click ‘Enable Margin’ button and will be taken to | |
| | | the Portfolio>Borrow page and get prompted a modal | |
| | | to set the max initial leverage. If it's the first time | |
| | | to set max initial leverage for this organization, the | |
| | | modal has a checkbox of Margin T&C | |

The system 100 imposes three requirements for Borrowers before borrowing can occur: (1) accept margin terms and conditions (T&C), (a) each organization needs to agree to Margin T&C once before users on the subaccount can borrow to trade, (b) authorized representative will accept the Margin T&C on behalf of the organization if it is the first time editing maximum initial leverage for the organization; (2) edit maximum initial leverage, (a) the rage of maximum initial leverage is approximately 1× to 3×, the value can be changed by 0.5 incrementally (margin is enabled when maximum initial leverage is set higher than 1× and disabled when it is set at 1×), (b) the maximum initial leverage value is set via a slider control (the far left of the slider represents 1× or no leverage or margin, the far right represents 3× and is the maximum initial leverage at the exchange level, this value should be the same for all clients on day 1), (c) maximum borrowable and maximum initial leverage would update accordingly as the user slides the slider; and (3) under different margin statuses, users can perform different actions. T&C apply account-wide, to a user's main account and subaccounts. Each user persona has different action permissions, thus seeing slightly different UIs on the Portfolio screen, for example, see the table below:

| | a. Margin is ineligible | | |
|---|---|---|---|
| Status | for this organization | b. Margin is not enabled for this subaccount | c. Margin is enabled for this subaccount |
| Trader | Margin module is | 1. ‘No leverage’ is displayed in the Margin module | Max initial leverage is displayed on |
| | disabled | Copy: | the dashboard |
| | | Want to unlock more trading power? | |
| | | Contact your oranization's | |
| | | Authorized Representative to enable margin trading | |
| | | Link: Learn More | |
| | | 1. Click ‘Learn More’ and will be taken to | |
| | | the Help Center | |
| Authorized | Margin module is | 1. ‘No leverage’ is displayed in the Margin module | 1. Max initial leverage is displayed |
| Representative | disabled | 1. Click ‘Edit’ or ‘Enable Margin’ button and will be | on the dashboard |
| | | be prompted a modal to set the max initial leverage. | 2. Click ‘Edit’ and can update the max |
| | | If it's the first time to set | initial leverage |
| | | max initial leverage for this organization, the modal | |
| | | has a checkbox of Margin T&C | |
| | | Copy: | |
| | | “Enable margin on this account to unlock | |
| | | more trading power.” | |

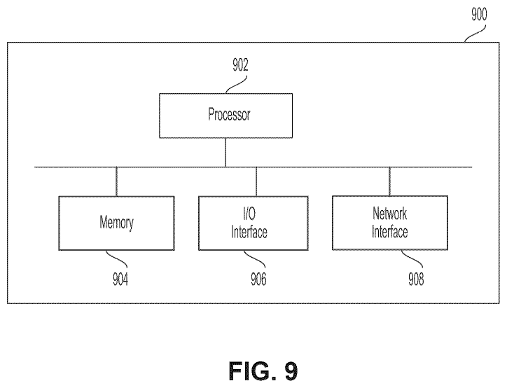

FIG. 9 is a schematic diagram of an electronic device 900 for on-demand margin lending and borrowing. As depicted, electronic device 900 includes at least one processor 902, memory 904, at least one I/O interface 906, and at least one network interface 908.

Each processor 902 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 904 may include a suitable combination of any type of computer memory that is located either internally or externally such as, for example, random access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 906 enables electronic device 900 to interconnect with one or more input devices, such as a keyboard, mouse, camera, touch screen and a microphone, or with one or more output devices such as a display screen and a speaker.

Each network interface 908 enables electronic device 900 to communicate with other components, to exchange data with other components, to access and connect to network resources, to serve applications, and perform other computing applications by connecting to a network (or multiple networks) capable of carrying data.

The current operational flow for bringing the exchange platform (or system 100) back up after downtime includes: (1) before the exchange maintenance window, open orders are cancelled on behalf of customers; (2) 15 minutes before the end of the maintenance window, (a) customers are allowed to deposit (deposits are pending during this period), create or terminate AMM instructions on the per market level, and (b) order entry for one market as part of internal testing for a sanity check is enabled (verified orders show up on the order book and orders can be filled) and a test order from a test account is sent (cross the order against AMM); and (3) at the end of the maintenance window, order entry for all markets in a bulk action is enabled and all customers are notified.

The Margin Day 1 operational flow for brining the exchange back up after downtime includes: (1) before the exchange maintenance window, open orders are cancelled on behalf of the customer; (2) 30 minutes before the end of the maintenance window, (a) deposit and transfer in is enabled, cancellation and terminate AMM instructions for all markets in a bulk action is ordered, and (b) order entry for a market (USDT/USDC) for sanity check is turned on, a test order from a test account is sent (cross the order against AMM); and (3) end of the maintenance window, order entry for all markets via bulk action in CTRL should be turned on, and all customers informed.

The embodiments of the devices, systems, and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide better memory usage, improved processing, and/or improved bandwidth usage.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A computer system for on-demand margin borrowing and lending comprising:
a memory storing historical trading data and instructions for a plurality of customer accounts, each customer account being a unified trading account;
a hardware processor executing instructions to provide a margin processor configured to provide margin operations for the plurality of customer accounts for on-demand margin lending, on-demand margin borrowing, and interest charges,
wherein the margin processor:
determines that the customer account is operating in a margin mode to use assets on-demand for trading activities, wherein the computer system uses assets in the customer account as collateral for the trading activities,
continuously computes a margin value for the customer account based on a collateral rating for the assets in the customer account used as collateral for the trading activities, wherein the collateral rating reflects a quality of the assets in the customer account based on a statistical analysis of historical trading data to determine, for each type of the assets in the customer account, a quality rating for a respective type of the asset in the customer account as an assessment of volatility or market risk of the asset in the customer account and an ability to liquidate the asset in the customer account, wherein the collateral rating is adapted to change proportionally with a value of the assets in the customer account, and
automatically controls the trading activities for the customer account operating in the margin mode using the continuously computed margin value for the customer account; and
a margin interface that outputs one or more visual elements corresponding to at least a portion of the margin value for the customer account operating in the margin mode, and updates the one or more visual elements as the margin value is continuously computed, wherein the margin interface further comprises a margin toggle configured to activate or deactivate the margin mode.

2. The computer system of claim 1, wherein the margin processor sets one or more margin requirements for the customer account, and continuously compares the margin value for the customer account to the margin requirements to evaluate risk for the customer account, wherein the margin processor controls the trading activities for the customer account operating in the margin mode using the one or more margin requirements.

3. The computer system of claim 2, wherein the margin processor computes a health indicator for the customer account based on the margin value and the margin requirements, the health indicator corresponding to one or more permitted actions for the customer account, wherein the computer system executes code to control activities for the customer account using the one or more permitted actions corresponding to the health indicator for the customer account.

4. The computer system of claim 3, wherein upon determining that the margin value for the customer account does not meet the margin requirements for the customer account, the margin processor updates the one or more permitted actions for the customer account, wherein upon receiving a request for an activity for a customer account, the system verifies the one or more permitted actions corresponding to the health indicator for the customer account before implementing the requested activity, wherein upon determining that the requested activity is not include in the one or more permitted actions corresponding to the health indicator for the customer account, the computer system rejects the request for the activity for the customer account.

5. The computer system of claim 1, wherein the margin processor computes the collateral rating for the assets in the customer account used as collateral for the trading activities by discounting a normalized value of all types of assets in the customer account by a rating reflective of a quality measure of the assets in the customer account, wherein a higher quality asset will have a higher rating and lower haircut, and a lower quality asset will have a lower rating and higher haircut.

6. The computer system of claim 1, wherein the margin processor computes the collateral rating for the assets in the customer account as collateral value-haircut, wherein the collateral value is a normalized value of the assets in the customer account and a haircut reflects a quality measure of the assets in the customer account, wherein a higher rating reflects a lower haircut, and a lower rating reflects a higher haircut.

7. The computer system of claim 1, wherein the margin processor computes the margin value for the customer account as:
margin=(collateral value−haircut)+futures pnl−debt.

8. The computer system of claim 1, further comprising a dispatcher, a matcher, a marginer, a market maker, and an accountant engine to implement one or more of the trading activities for the customer account.

9. The computer system of claim 1, wherein the margin processor:
enables margin trading on a subaccount;
sets margin requirements for the subaccount;
processes a loan request to buy or sell an asset from a borrower interface;
processes a loan offer to generate returns from idle assets from a lender interface;
determines rates for assets in the customer account;
executes a margin transaction between the borrower interface and the lender interface, the margin transaction being smart contract code for a blockchain infrastructure; and
computes different types of margin data, and generate output for transmission, storage or display at the margin interface.

10. The computer system of claim 2, wherein the margin processor is further configured to automatically update the one or more visual elements of the margin interface using output data relating to a margin transaction, the one or more visual elements indicating a risk value for the margin transaction and the margin requirements for a subaccount.

11. The computer system of claim 2, further comprising a liquidation engine configured to process automatic de-leveraging of a subaccount, wherein the liquidation engine automatically liquidates assets in the subaccount when a leverage threshold value of the subaccount is above a safety threshold value.

12. The computer system of claim 11, wherein the safety threshold value is at least one of:
a default value; and
an adaptive value configured by the computer system in response to continuously computing the margin value.

13. The computer system of claim 11, wherein the liquidation engine is further configured to set a liquidation price of an asset held in the subaccount.

14. The computer system of claim 13, wherein output data relating to a margin transaction includes an impact of a planned margin transaction, wherein the impact of the planned margin transaction is determined by the margin processor and the impact of the planned action is at least one of:
additional assets that will be borrowed as a result of the planned margin transaction;
a total of the additional assets that will be borrowed as a result of the planned margin transaction;
an asset price at which a user will lose control of the subaccount to the liquidation engine as a result of the planned margin transaction;
an expected leverage of the subaccount as a result of the planned margin transaction;
expected fees as a result of the planned margin transaction; and
an expected notional as a result of the planned margin transaction.

15. The computer system of claim 9, wherein the margin processor is further configured to automatically process repayment of at least one loan of the subaccount by selling idle assets of the subaccount, wherein the margin processor is configured to determine the at least one loan by calculating the at least one loan with the highest loan rate, wherein the margin processor is further configured to automatically processes a repayment of the at least one loan of the subaccount at a regular interval.

16. (canceled)

17. The computer system of claim 1, wherein the margin processor is further configured to process loan return data and loan capacity data for at least one of:
an individual loan offer; and
an aggregate of loan offers.

18. The computer system of claim 9, wherein the margin processor uses open order collateral assets in the subaccount for cross-collateralization, wherein the margin processor is further configured to set a leverage characterization status of the subaccount, the margin processor processing a current leverage value of the subaccount and a leverage threshold value of the subaccount to set the leverage characterization.

19. The computer system of claim 3, wherein the health indicator comprises a status selected from the group of healthy, monitor, danger, critical, and suspended.

20. (canceled)

21. A method for on-demand margin borrowing and lending executing instructions stored on memory by a hardware processor, the method comprising:
determining that a customer account is operating in a margin mode to borrow assets on-demand for trading activities, wherein a trading system automatically uses assets in the customer account as collateral for the trading activities upon determining that the customer account is operating in the margin mode; and
continuously computing a margin value for the customer account based on a collateral rating for the assets in the customer account used as collateral for the trading activities, wherein the collateral rating reflects a quality of the assets in the customer account based on a statistical analysis of historical trading data to determine, for each type of the assets in the customer account, a quality rating for a respective type of asset in the customer account as an assessment of volatility or market risk of the asset in the customer account and an ability to liquidate the asset in the customer account, wherein the collateral rating is adapted to change proportionally with a value of the assets in the customer account;
automatically controlling the trading activities for the customer account operating in the margin mode using the continuously computed margin value for the customer account;
outputting, at a margin interface, one or more visual elements corresponding to at least a portion of the margin value for the customer account operating in the margin mode, and updating the one or more visual elements as the margin value is continuously computed.

22. A non-transitory machine readable medium having stored thereon a plurality of instructions that, when executed by at least one computing device, cause the at least one computing device to perform the method of claim 21.
